(19) United States
(12) Patent Application Publication
(10) Pub. No.: US 2004/0064475 A1
(43) Pub. Date: Apr. 1, 2004

(54) Methods for progressive encoding and multiplexing of web pages

(75) Inventors: Junji Maeda, Setagaya-ku (JP); Hironobu Takagi, Meguro-ku (JP)

Correspondence Address: RICHARD M. GOLDMAN, 371 ELAN VILLAGE LANE, SUITE 208, CA, 95134, US

(73) Assignee: International Business Machines Corporation, Armonk, NY

(21) Appl. No.: 10/667,712

(22) Filed: Sep. 22, 2003

(30) Foreign Application Priority Data
Sep. 27, 2002 (JP) JP2002-284536

(51) Int. Cl. G06F 17/00

(52) U.S. Cl. 707/103 Y

(57) ABSTRACT

The method, system, and program product enable a receiving-side user to speedily obtain important information in tree-structured documents even if the size of the received tree structure is large. This is accomplished by setting a node priority with respect to each of nodes of a tree-structured document. The priority is set based on the basis of the importance of an information portion presented from the node to a receiving-side user. Node stream generation means generate a node stream in which nodes and/or subtrees of a tree-structured document to be transmitted are arranged in sequence according to node priorities. Transmitting means send the node stream to tree-structured document receiving apparatus via a network. In tree-structured document receiving apparatus, extraction means extract the nodes and/or subtrees in the node stream according to the sequence of arrangement, and reconstruction means add the nodes and/or subtrees in the extraction order to the tree-structured document under reconstruction. Display means display the tree-structured document in the current reconstructed state.

### FIELD OF THE INVENTION

The present invention relates to a tree-structured document transmitting and receiving system, a tree-structured document transmitting apparatus, a tree-structured document receiving apparatus, a tree-structured document transmitting and receiving method, a tree-structured document transmitting method and a tree-structured document receiving method arranged to achieve improved display of a tree-structured document (a tree-structured document or a tree-structured file) at a receiving side, and a program for causing a computer to execute the steps of each method.

### BACKGROUND

In recent years, many document formats based on a tree structure such as HTML (HyperText Markup Language) and XML (Extensible Markup Language) or SVG (Scalable Vector Graphics) and X3D (Extensible 3D) derived from HTML or XML have been established, and data in such formats has been exchanged via communication lines. A tree structure in these data formats is traversed in depth-first order, changed into one-dimensional data (stream), and transmitted and received. The order in which data is transmitted and received is ordinarily the same as the depth-first traversing order corresponding to the description order and is fixed. Thus, a flexibility for transmitting an important portion first, for example, has not been provided. In the case of a document for a display purpose, the entire composition cannot be grasped at a receiving side before the end of the data is received. These problems become serious if the volume of a document to be handled is increased or if the number of files handled at a time is increased.

For example, the Internet Explorer (trademark) of Microsoft Corporation has a function “Progressive Rendering” for display of HTML documents. “Progressive” in this name signifies that a portion of data on a document received in a certain time period from a start of transmission of the data is displayed and a remaining data portion is successively displayed “upon receipt”. The order in which data portions are transmitted is irrelevant to the display order in the data structure. More specifically, progressive rendering is the function of performing a process in which the contents of an HTML text main portion of a small data amount are first displayed and an image requiring data acquisition for a long time is then displayed at a designated position upon receipt of the image. In this process, however, data on the HTML text main portion is also transmitted in depth-first order without flexibility.

As a technique relating to a document for a display purpose, a technique for transmitting “thumbnail image” to immediately display a document in outline is known. A technique is also conceivable in which a miniature in the same format as that of an original document is made in advance and is first transmitted. These techniques are effective to a degree in enabling a user to know an outline in a short time, but each do not ensure that the effect according to user's need can be obtained, because the resolution and the amount of data are fixed, and because there is a possibility of the resolution being considerably low or so excessively high that an amount of communication is wasted. Also, each of these techniques is incapable of flexible processing, e.g., processing enabling a portion containing a particular keyword or a particular ID to be transmitted with priority.

Japanese Patent Application No. 11-65958 (especially FIG. 3) and Japanese Patent Application No. 2000-83059 (especially FIGS. 5 and 11) describe techniques comprising transmitting tree-structured data in breadth-first order. The tree structure handled by the technique described in Japanese Patent Application No. 11-65958 is used only for the purpose of sorting information. That is, nodes of one tree-structured document are transmitted and received in a predetermined sequence, but the order in which the plurality of nodes of the tree-structured document are displayed by a receiving-side display means is not controlled. In the information transmitting method described in Japanese Patent Application 11-65958 data displayed as appropriate on a display means by a user is one predetermined node sorted by a receiving-side information accumulation means.

Japanese Patent Application No. 2000-83059 describes a tree structure in which tree-structured data is not data to be displayed on a display means by a user at a receiving side but index information which is used by the receiving-side user in search for data to be displayed on the display means. The receiving-side user displays on the display means the tree structure index information corresponding to one node. A plurality of nodes of one tree-structured document are not displayed in a predetermined sequence on the display means.

On the other hand, in a tree-structured document such as an HTML or XML document, concrete data (e.g., a text of a description on a newspaper Web page) exists at leaf nodes and cannot be effectively utilized at an intermediate stage if it is transmitted and received in a simple breadth-first method such as that described in the above documents For example, any portion of an HTML document containing no leaf node cannot be immediately displayed. In many cases, there are differences in importance between nodes, as recognized from the viewpoint of display or information access (for example, in HTML documents as a result of a search, portions containing keywords used for the search). In Patent Documents 1 and 2, the attributes of nodes are not taken into consideration.

Thus, there is a need to provide a tree-structured document transmitting and receiving system, a tree-structured document transmitting apparatus, a tree-structured document receiving apparatus, a tree-structured document transmitting and receiving method, a tree-structured document transmitting method and a tree-structured document receiving method arranged to enable progressive display in a system in which documents expressed in a tree structure are transmitted and received and in which display is performed at a receiving side, and to enable the outline of displayed contents of a document to be grasped at an intermediate stage without waiting the completion of communication at the receiving side even if the volume of the document is large or the number of files handled at a time is large, and a program for causing a computer to execute the steps of each method.

“Progressive” denotes a system in which the outline of the whole of data can be grasped even when only part of the data is present because of a certain communication condition for example, and in which details of the data becomes visible as the amount of data is increased. In contrast, the conventional methods are “sequential” methods such that detailed portions are collected little by little (typically from an upper left position to lower right position) to finally form the whole.

Another requirement is to provide a tree-structured document transmitting and receiving system, a tree-structured document transmitting apparatus, a tree-structured document receiving apparatus, a tree-structured document transmitting and receiving method, a tree-structured document transmitting method and a tree-structured document receiving method arranged so that a demand from a user at a transmitting side or a receiving side can be reflected in the way in which displayed contents appear at the receiving side, and a program for causing a computer to execute the steps of each method.

### SUMMARY OF THE INVENTION

According to the present invention, nodes and/or subtrees of a tree-structured document to be transmitted is transmitted from a transmitting side in a sequence based on node priorities set on the basis of the importance of information portions to be presented from the nodes to a receiving-side user, and the tree-structured document is reconstructed at a receiving side to be displayed, thereby enabling a receiving-side user to obtain necessary or important information about the tree-structured document without waiting for the completion of receiving of the entire tree-structured document

A tree-structured document transmitting and receiving system of the present invention has a tree-structured document transmitting apparatus and a tree-structured document receiving apparatus. The tree-structured document transmitting apparatus has tree-structured document storage means of storing a plurality of tree-structured documents, node priority presentation means of presenting a node priority which is set with respect to each of nodes of a tree-structured document on the basis of the importance of an information portion to be presented from the node to a receiving-side user while satisfying two conditions: a first condition that the node priority of the node is equal to or lower than that of a node which is an ancestor of that node, and a second condition that if a plurality of nodes of the same priority exist, the nodes necessarily constitute one subtree, node stream generation means of reading out a tree-structured document to be transmitted from the tree-structured document storage means and generating a node stream in which nodes and/or subtrees are arranged in a sequence on the basis of node priorities presented by the node priority presentation means, and transmitting means of converting the node stream into a signal based on a predetermined network protocol and transmitting the signal. The tree-structured document receiving apparatus has receiving means of restoring the node stream from the signal received by the predetermined network protocol from the transmitting means, extraction means of extracting the nodes and/or subtrees from the node stream restored by the receiving means according to the sequence of arrangement in the node stream, reconstruction means of adding the nodes and/or subtree in the extraction order to the tree-structured document under reconstruction, and display means of displaying the tree-structured document in the current reconstructed state.

Another tree-structured document transmitting and receiving system of the present invention has a tree-structured document transmitting apparatus and a tree-structured document receiving apparatus. The tree-structured document transmitting apparatus has tree-structured document storage means of storing a plurality of tree-structured documents, a plurality of document-by-document encoding means each assigned processing of one tree-structured document in a plurality of tree-structured documents to be transmitted, and each having node priority presentation means and node stream generation means, the node priority presentation means presenting a node priority which is set with respect to each of nodes of the assigned tree-structured document on the basis of the importance of an information portion to be presented from the node to a receiving-side user while satisfying two conditions: a first condition that the node priority of the node is equal to or lower than that of a node which is an ancestor of that node, and a second condition that if a plurality of nodes of the same priority exist, the nodes necessarily constitute one subtree, the node stream generation means reading out a tree-structured document to be transmitted from the tree-structured document storage means and generating a node stream in which nodes and/or subtrees are arranged in a sequence on the basis of node priorities presented by the node priority presentation means, inter-document priority presentation means of presenting inter-document priorities set as transmission priorities with respect to the plurality of tree-structured documents to be transmitted, multiplexed stream generation means of generating one multiplexed stream by multiplexing the node streams from the document-by-document encoding means, sequences in which the nodes and/or subtrees of the tree-structured documents are arranged being placed in the multiplexed stream according to the inter-document priorities presented by the inter-document priority presentation means with respect to the tree-structured documents, and transmitting means of transmitting the multiplexed stream by converting the multiplexed stream on the basis of a predetermined network protocol. The tree-structured document receiving apparatus has receiving means of restoring the multiplexed stream from the signal received by the predetermined network protocol from the transmitting means, demultiplexing means of demultiplexing the multiplexed stream into the plurality of node streams contained in the multiplexed stream, a plurality of document-by-document decoding means each assigned processing of one node stream in the plurality of node streams demultiplexed by the demultiplexing means, and each including extraction means and reconstruction means, the extraction means extracting the nodes and/or subtrees from the processing-assigned node stream according to the sequence of arrangement in the node stream, the reconstruction means adding the nodes and/or subtree in the extraction order to the tree-structured document under reconstruction, and display means of displaying the tree-structured document under reconstruction in each document-by-document decoding means, the tree structure being displayed in the current reconstructed state at a corresponding position.

A tree-structured document transmitting and receiving method of the present invention has a tree-structured document transmitting method and a tree-structured document receiving method. The tree-structured document transmitting method has a node stream generation step of generating a node stream in such a manner that a node priority is set with respect to each of nodes of a tree-structured document on the basis of the importance of an information portion to be presented from the node to a receiving-side user while satisfying two conditions: a first condition that the node priority of the node is equal to or lower than that of a node which is an ancestor of that node, and a second condition that if a plurality of nodes of the same priority exist, the nodes necessarily constitute one subtree, a tree-structured document to be transmitted is read out from tree-structured document storage means, and nodes and/or subtrees of the tree-structured document are arranged in a sequence on the basis of the node priorities, and a transmitting step of converting the node stream into a signal based on a predetermined network protocol and transmitting the signal. The tree-structured document receiving method has a receiving step of restoring the node stream from the signal received by the predetermined network protocol, an extraction step of extracting the nodes and/or subtrees from the node stream restored in the receiving step according to the sequence of arrangement in the node stream, a reconstruction step of adding the extracted nodes and/or subtree in the extraction order to the tree-structured document under reconstruction, and a display step of displaying on the display means the tree-structured document in the current reconstructed state.

Another tree-structured document transmitting and receiving method of the present invention has a tree-structured document transmitting method and a tree-structured document receiving method. The tree-structured document transmitting method has a plurality of document-by-document encoding steps each assigned processing of one tree-structured document in a plurality of tree-structured documents to be transmitted, and each including a node stream generation substep comprising generating a node stream in such a manner that a node priority is set with respect to each of nodes of a tree-structured document on the basis of the importance of an information portion to be presented from the node to a receiving-side user while satisfying two conditions: a first condition that the node priority of the node as a priority is equal to or lower than that of a node which is an ancestor of that node, and a second condition that if a plurality of nodes of the same priority exist, the nodes necessarily constitute one subtree, one assigned tree-structured document is read out from tree-structured document storage means, and nodes and/or subtrees of the tree-structured document are arranged in a sequence on the basis of the node priorities, a multiplexed stream generation step of generating one multiplexed stream by multiplexing the node streams in the document-by-document encoding steps, inter-document priorities being set as transmission priorities with respect to the plurality of tree-structured documents to be transmitted, sequences in which the nodes and/or subtrees of the tree-structured documents are arranged being placed in the multiplexed stream according to the inter-document priorities with respect to the tree-structured documents, and a transmitting step of transmitting the multiplexed stream by converting the multiplexed stream on the basis of a predetermined network protocol. The tree-structured document receiving method has a receiving step of restoring the multiplexed stream from the signal received by the predetermined network protocol, a demultiplexing step of demultiplexing the multiplexed stream into the plurality of node streams contained in the multiplexed stream, a plurality of document-by-document decoding steps each assigned processing of one node stream in the plurality of node streams demultiplexed in the demultiplexing step, and each including an extraction substep and a reconstruction substep, the extraction substep comprising extracting the nodes and/or subtrees from the processing-assigned node stream according to the sequence of arrangement in the node stream, the reconstruction substep comprising adding the nodes and/or subtree extracted in the extraction substep in the extraction order to the tree-structured document under reconstruction, and a display step of displaying the tree-structured document under reconstruction in each document-by-document decoding step, the tree structure being displayed in the current reconstructed state at a corresponding position of the display means.

### THE FIGURES

FIG. 1 is a diagram of the configuration of a tree-structured document transmitting and receiving system;

FIG. 2 is a diagram for explaining traverse of a tree-structured document;

FIG. 3 is a diagram of the configuration of a tree-structured document transmitting apparatus;

FIG. 4 is a block diagram of a tree-structured document transmitting apparatus to which functions are added;

FIG. 5 is a block diagram of a tree-structured document receiving apparatus;

FIG. 6 is a block diagram of a tree-structured document transmitting apparatus;

FIG. 7 is a detailed block diagram of document-by-document encoding means;

FIG. 8 is a block diagram of a tree-structured document transmitting apparatus having several functions in addition to the functions of the tree-structured document transmitting apparatus shown in FIG. 6;

FIG. 9 is a block diagram of a tree-structured document receiving apparatus;

FIG. 10 is a block diagram of a tree-structured document receiving apparatus having several functions in addition to the functions of the tree-structured document receiving apparatus shown in FIG. 9;

FIG. 11 is a flowchart of a tree-structured document transmitting routine in a tree-structured document transmitting and receiving system in which a single tree-structured document is processed;

FIG. 12 is a tree-structured document transmitting routine formed by adding a step to the tree-structured document transmitting routine shown in FIG. 11;

FIG. 13 is a flowchart for concretely explaining the node priority setting processing shown in FIG. 11;

FIG. 14 is a flowchart of a tree-structured document receiving routine in the tree-structured document transmitting and receiving system in which a single tree-structured document is processed;

FIG. 15 is flowchart of a tree-structured document receiving routine formed by changing part of the steps shown in FIG. 14;

FIG. 16 is flowchart of a tree-structured document receiving routine formed by changing part of the steps shown in FIG. 15;

FIG. 17 is a flowchart of a tree-structured document transmitting routine in a tree-structured document transmitting and receiving system in which a plurality of tree-structured documents are processed;

FIG. 18 is a concrete flowchart of processing in S105 shown in FIG. 17;

FIG. 19 is a flowchart of a tree-structured document receiving routine in the tree-structured document transmitting and receiving system in which a plurality of tree-structured documents are processed;

FIG. 20 is a diagram showing a sequence in which nodes on a tree structure are searched in breadth-first search;

FIG. 21 is a diagram showing a sequence in which nodes on a tree structure are searched in priority sequence search;

FIG. 22 is a block diagram of a transmitting apparatus;

FIG. 23 is a block diagram of a receiving apparatus compatible with the transmitting apparatus shown in FIG. 22;

FIG. 24 is a diagram for explaining a node transmission sequence when substitute display based on descendant nodes substitute information is performed in the receiving apparatus;

FIG. 25 is a block diagram of a transmitting apparatus having descendant nodes substitute information processing function;

FIG. 26 is a block diagram of a receiving apparatus which receives data from the transmitting apparatus shown in FIG. 25;

FIG. 27 is a block diagram of a transmitting apparatus which simultaneously transmits a plurality of files by combining the files;

FIG. 28 is a block diagram of a receiving apparatus which receives data from the transmitting apparatus shown in FIG. 27;

FIG. 29 is a diagram showing an example of display of an on-screen image on a receiving apparatus side (sales person use side) in a tree-structured document transmitting and receiving system enabling a receiving-side user to change inter-file priorities as desired while simultaneously receiving a plurality of files;

FIG. 30 is a block diagram of a transmitting apparatus for enabling a receiving-side user to perform operations using the on-screen image shown in FIG. 29;

FIG. 31 is a block diagram of a receiving apparatus 1100 for enabling a receiving-side user to perform operations using the on-screen image shown in FIG. 29;

FIG. 32 is a tree structure diagram for explaining a change in priority made by a transmitting-side user;

FIG. 33 is a block diagram of a transmitting apparatus having the function of changing priorities by an operation performed by a transmitting-side user in a tree-structured document transmitting and receiving system;

FIG. 34 is diagram showing an example of an on-screen image at an initial stage of downloading of an HTML document without descendant substitute display;

FIG. 35 is diagram showing an example of an on-screen image at an initial stage of downloading of an HTML document when descendant substitute display is performed;

FIG. 36 is diagram showing an example of an on-screen image at an intermediate stage of downloading of an HTML document without descendant substitute display;

FIG. 37 is diagram showing an example of an on-screen image at an intermediate stage of downloading of an HTML document when descendant substitute display is performed; and

FIG. 38 is diagram showing an example of an on-screen image at a receiving side when an HTML document provided as a tree-structured document is processed in accordance with the present invention.

### DETAILED DESCRIPTION

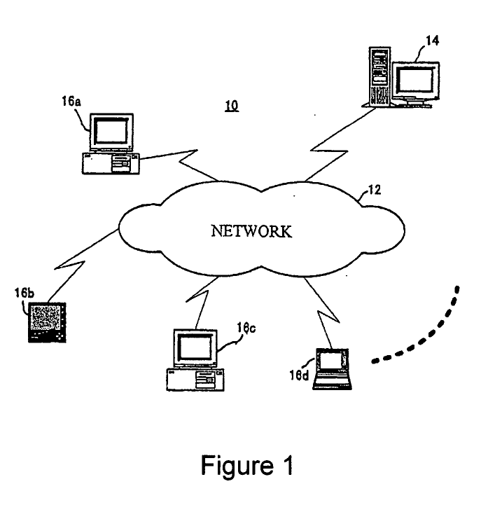

FIG. 1 is a diagram showing the configuration of a tree-structured document transmitting and receiving system 10. A network 12 is formed by the Internet, an intranet or a LAN, for example. A tree-structured document server 14 and a plurality of tree-structured document clients, i.e., PCs (personal computers) 16a, 16b, 16c, 16d, are connected to the tree-structured document transmitting and receiving system 10. In Embodiments 2 to 4 described below, a tree-structured document is transmitted from the tree-structured document server 14 to each PC 16. In Embodiment 5 described below (remote electronic conference system or CRM), tree-structured documents are transmitted and received between PCs 16.

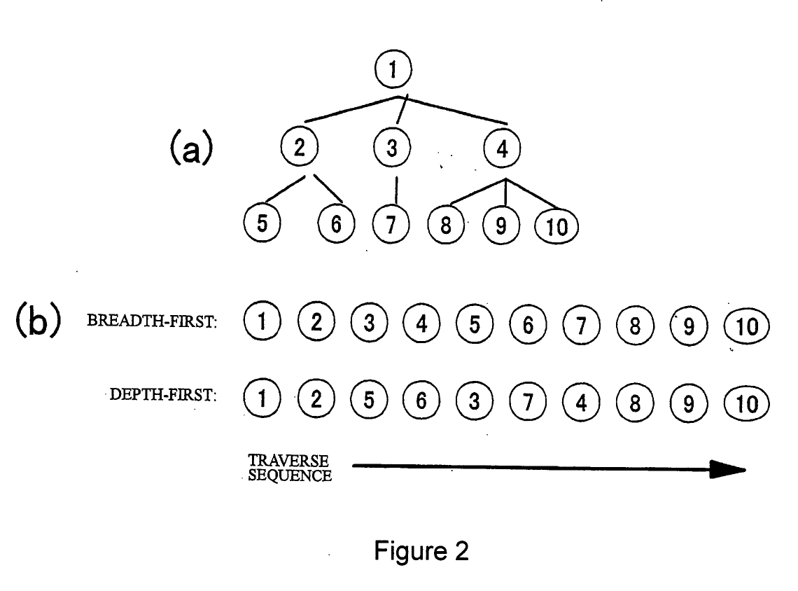

FIG. 2 is a diagram for explaining traverse of a tree-structured document. In (a) of FIG. 2, numbers for nodes in the tree structure are shown. In (b) of FIG. 2, breadth-first traverse and depth-first traverse are shown. In breadth-first traverse, traverse of all the nodes in the tree structure is performed by repeating a process in which all the nodes at the same hierarchical level are visited and, after this visit, traverse of the nodes at the next hierarchical level is performed. In depth-first traverse, traverse of all the nodes in the tree structure is performed by repeating a process in which traversing from a root node to a leaf node is performed and, after this leaf node has been visited, traversing along a branch from the branching point closest to this leaf node to a leaf node at the end of this branch is performed. According to the present invention, traverse different from breadth-first and depth-first traverse strategy is used, as described below. Priorities with which the nodes are visited and priorities with which the nodes are transmitted typically coincide with each other but may be different from each other. A subtree in the tree structure is an extracted combination of one node and connected descendant nodes in one or a plurality of generations in the entire tree structure. According to the present invention, nodes belonging to one subtree are given the same priority.

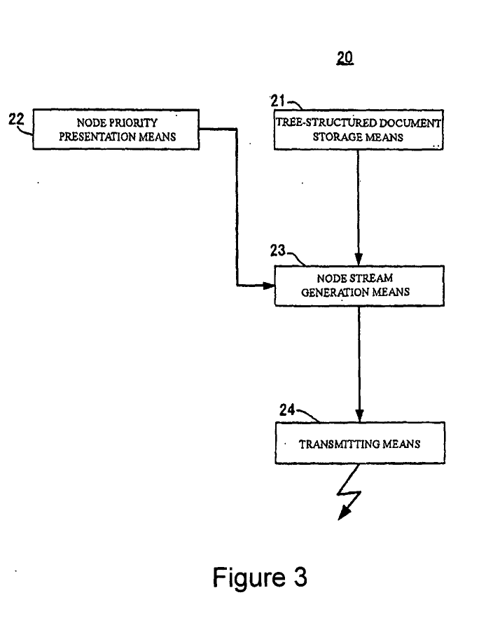

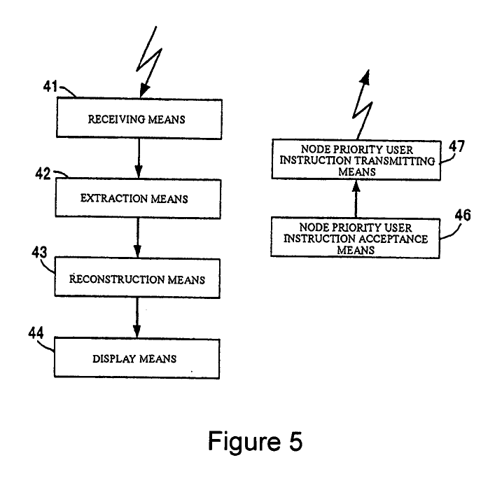

FIG. 3 is a block diagram of a tree-structured document transmitting apparatus 20. A tree-structured document storage means 21 stores a plurality of tree-structured documents, e.g., HTML documents, XML documents, SVG documents, and X3D documents. A node priority presentation means 22 presents a node priority which is set with respect to each node of a tree-structured document on the basis of the importance of an information portion to be presented from the node to a receiving-side user while satisfying two conditions: a first condition that the node priority of the node is equal to or lower than that of a node which is an ancestor of that node, and a second condition that if a plurality of nodes of the same priority exist, the nodes necessarily constitute one subtree. The first and second conditions in setting node priorities are provided for the purpose of enabling tree-structured documents to be smoothly reconstructed by a reconstruction means in a receiving apparatus 40 (FIG. 5). In reconstructing a tree-structured document, if the first condition is not satisfied, descendant nodes may be received by the receiving apparatus 40 prior to the ancestor node from which the descendant node is descended. In such a situation, a hitch occurs in reconstruction on the receiving side such that there is no point to which the descendant node is to be connected in the tree structure at the present reconstruction stage, that is, it is difficult to connect the descendant node. If the first condition is satisfied, the construction of a tree-structured portion containing the ancestor node from which the received node of the tree-structured document is descended is completed when this node is received by the receiving apparatus 40, that is, a point exists to which the received node is to be connected in the tree structure at the present reconstruction stage. In this case, the received node can be connected to the point and the process of reconstructing the tree-structured document can be steadily advanced to complete the reconstruction. The second condition is required to enable nodes contained in one tree structure to be transmitted together. A node stream generation means 23 reads out of the tree-structured document storage means 21 a tree-structured document to be transmitted and generates a node stream in which nodes and/or subtrees are arranged in a sequence on the basis of node priorities presented by the node priority presentation means 22. A transmitting means 24 converts the node stream into a signal on the basis of a predetermined network protocol (e.g., TCP/IP) and transmits this signal.

In some case, a tree-structured document such as an HTML document has information such as a style sheet not belonging to any tree structure. Such information other than tree-structured data is transmitted from the tree-structured document transmitting apparatus 20 to the tree-structured document receiving apparatus 40 (FIG. 5) in a sequence independent of tree structure node priorities. In ordinary cases, information other than tree-structured data is information which determines a tree structure display layout and it is preferable to transmit such information from the tree-structured document transmitting apparatus 20 to the tree-structured document receiving apparatus 40 before transmission of tree-structured data.

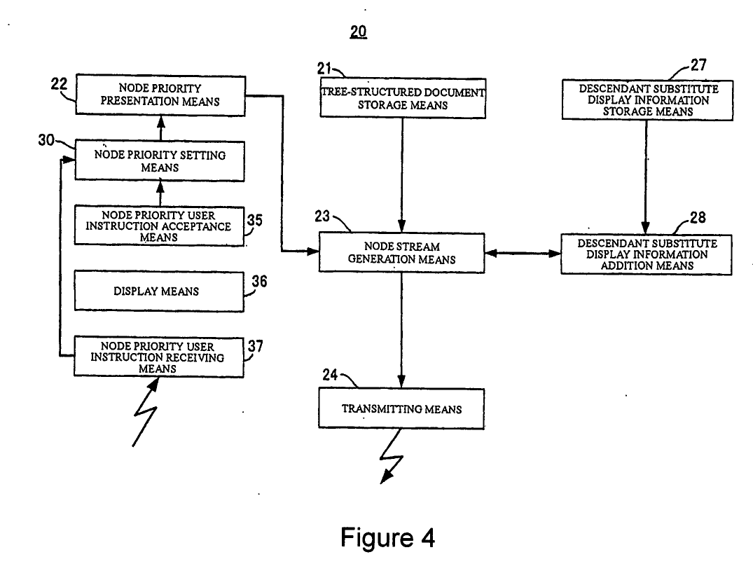

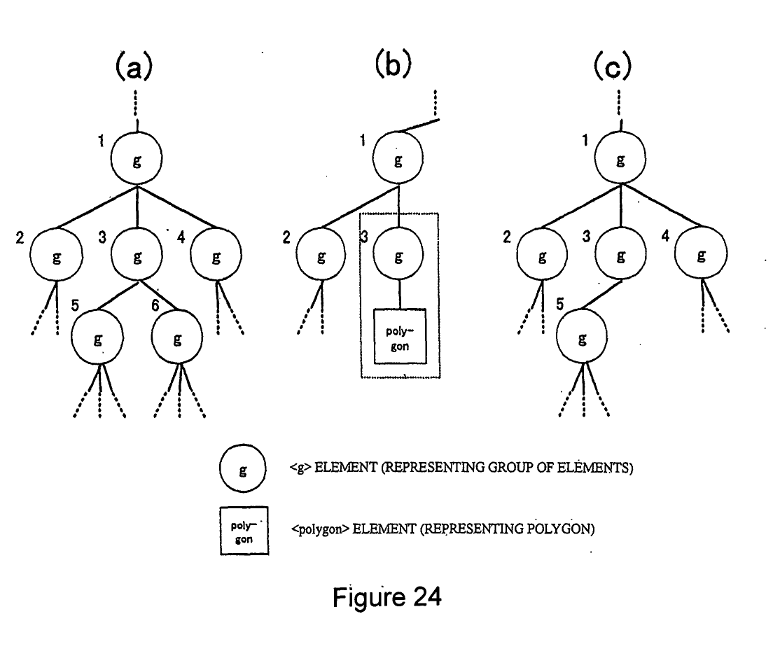

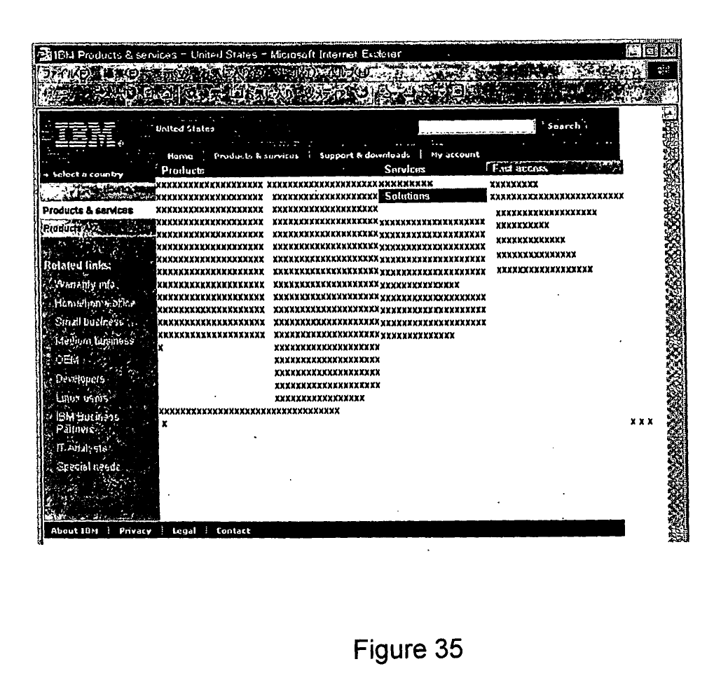

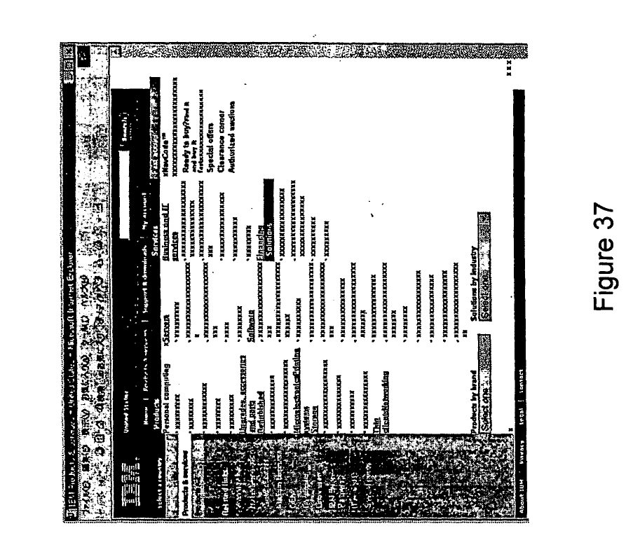

FIG. 4 is a block diagram of a function-added tree-structured document transmitting apparatus 20. The tree-structured document transmitting apparatus 20 shown in FIG. 4 has several functions in addition to the functions corresponding to those of the tree-structured document transmitting apparatus 20 shown in FIG. 3. A descendant substitute display information storage means 27 stores descendant substitute display information for substitute display on a display means 44 (FIG. 5) of the receiving apparatus for descendant nodes with respect to a node and/or a subtree existing as a parent of the descendant node. While in the illustrated arrangement the descendant substitute display information storage means 27 is provided separately from the tree-structured document storage means 21, the tree-structured document storage means 21 may also function as the descendant substitute display information storage means 27. It is not necessarily required that descendant substitute display information be stored in advance in the descendant substitute display information storage means 27. A descendant substitute display information item may be prepared as appropriate by processing a tree-structured document when a need arises to transmit it for the tree-structured document. For example, the number of characters for descendant nodes may be used as descendant substitute display information. The amount of data for descendant substitute display information is sufficiently smaller than the amount of data in the whole of descendant nodes for which the descendant substitute display information is substituted. Display of descendant substitute display information is simplified in comparison with display of the whole of descendant nodes for which the descendant substitute display information is substituted, and the time for transmission of the descendant substitute display information is much shorter than the time for transmission of the whole of the descendant node for which the descendant substitute display information is substituted. In a case where the number of characters of descendant nodes is selected as descendant substitute display information, there is a need to generate a concrete substitute display (displaying “x” for the number of characters at a corresponding position as shown in FIGS. 35 and 37) on the basis of information on the number of characters on the receiving side. Descendant substitute display information which can be immediately displayed as a descendant substitute display may be provided (for example, <polygon> elements having internal areas for complicated functional structure portions of component parts are used as descendant substitute display information in an SVG document in which a plan of a product is shown, as described below with reference to FIG. 24) if the amount of transmitted data can be sufficiently reduced by using the descendant substitute display information. Only one descendant node or a plurality of descendant nodes may be related to one descendant substitute display information item.

A descendant substitute display information addition means 28 makes the node stream generation means 23 generate as the above-mentioned node stream a stream in which descendant substitute display information for descendant nodes read out from the above-described descendant substitute display information storage means is added immediately after a node and/or a subtree existing as a parent of the descendant node. The node priority presentation means 22 presents a node priority set by a node priority setting means 30. As mentioned above, a node priority is set with respect to each node of a tree-structured document on the basis of the importance of an information portion to be presented from the node to a receiving-side user. Objects to be referred to for determination of the importance are, for example, a content of the node, an attribute of the node, a content of the document, an attribute of the document, the tree structure, a user instruction from a transmitting-side user, and/or a user instruction from a receiving-side user. The node priority setting means 30 sets the node priority on the basis of a content of the node, an attribute of the node, a content of the document, an attribute of the document, the tree structure, a user instruction from a transmitting-side user, and/or a user instruction from a receiving-side user. A user instruction from a transmitting-side user with respect to a node priority setting is received by a node priority user instruction acceptance means 35 and sent to the node priority setting means 30. A transmitting-side user may provide a suitable user instruction by making the display means 36 display a tree-structured document to be transmitted at the present time and by referring to the contents of the tree-structured document. For example, the node priority setting means 30 heightens the priority of nodes on an ancestor path from a node designated as a transmission-prioritized node by a transmitting-side user to a root node and the priority of nodes on any branch path branching from the ancestor path relative to the current priority. Preferably, the node priority setting means 30 increases the amount by which the priority of nodes on the ancestor path is heightened relative to the amount by which the priority of nodes on the branch path is heightened. It is also preferable that the node priority setting means 30 changes the amount by which the priority of nodes on the branch path is heightened in such a manner that the priority of one of the nodes closer to the branching point is higher than that of remoter ones. A node priority user instruction receiving means 37 receives an instruction about a node priority given by a receiving-side user and transmitted from a node priority user instruction transmitting means 47 in the tree-structured document receiving apparatus 40 described below. The node priority setting means 30 sets the node priority on the basis of a user instruction received by the node priority user instruction receiving means 37.

FIG. 5 is a block diagram of the tree-structured document receiving apparatus 40. The tree-structured document receiving apparatus 40 in the FIG. 5 receives nodes and/or subtrees from the tree-structured document transmitting apparatus 20 shown in FIG. 3. A receiving means 41 restores a node stream from a signal received by a predetermined network protocol. An extraction means 42 extracts nodes and/or subtrees from the node stream restored by the receiving means 41 according to the sequence of arrangement in the node stream. A reconstruction means 43 adds nodes and/or subtrees in extraction order to a tree-structured document under reconstruction. The display means 44 displays the tree-structured document in the current reconstructed state.

Several functions can be added to the tree-structured document receiving apparatus 40. Description will be given of the additional functions. A tree-structured document receiving apparatus 40 having added functions receives a node stream from the tree-structured document transmitting apparatus 20 shown in FIG. 4. The extraction means 42 extracts nodes and/or subtrees and descendant substitute display information from the node stream restored by the receiving means 41 according to the sequence of arrangement in the node stream. When the extraction means 42 extracts descendant substitute display information, the reconstruction means 43 adds a substitute tree-structured portion relating to the descendant substitute display information to a tree-structured document under reconstruction in place of the descendant node relating to the descendant substitute display information. When the extraction means 42 extracts the descendant node for which a substitute display is being produced on the basis of the descendant substitute display information, the reconstruction means 43 immediately replaces the substitute tree-structured portion relating to the descendant substitute display information with the descendant node in the tree structure under reconstruction. The tree-structured document receiving apparatus 40 further has a node priority user instruction acceptance means 46 and a node priority user instruction transmitting means 47. A user using the tree-structured document receiving apparatus 40 inputs a user instruction for a node priority setting to the node priority user instruction acceptance means 46. The user instruction provided by the receiving-side user with respect to the node priority of each node of a tree-structured document is prepared on the basis of the importance of the node itself, i.e., the importance of an information portion to be presented to the receiving-side user. For example, “the whole is outlined and is gradually detailed”, “a portion at a center of the whole is prioritized” and “a node having an ID “engine”, descendants from the same and peripheral nodes about the same are prioritized” are conceivable. The user instruction accepted by the node priority user instruction acceptance means 46 is supplied to the node priority user instruction transmitting means 47 and is transmitted from the node priority user instruction transmitting means 47 to the node priority user instruction receiving means 37 of the tree-structured document transmitting apparatus 20 via the network 12.

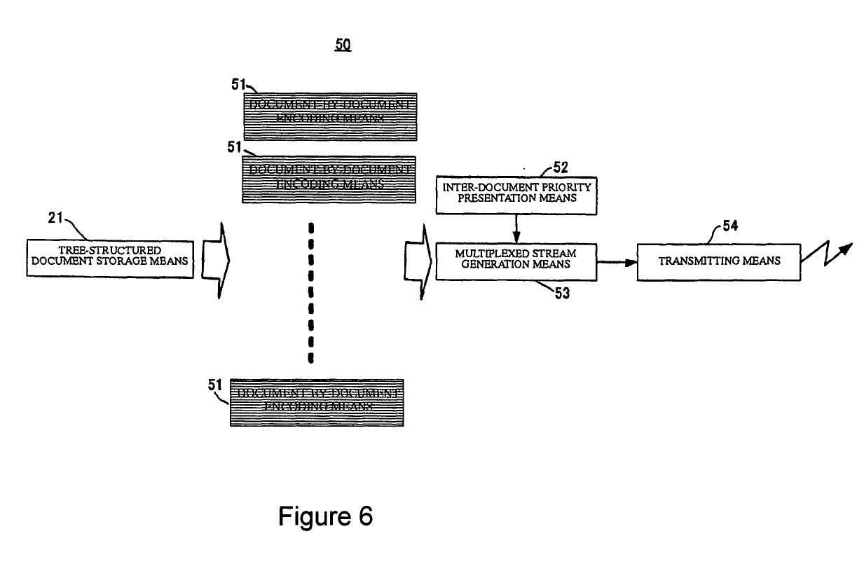

FIG. 6 is block diagram of a tree-structured document transmitting apparatus 50. While the tree-structured document transmitting apparatus 20 and the tree-structured document receiving apparatus 40 represent an example of application of the present invention in which an object to be transmitted is a single tree-structured document, the tree-structured document transmitting apparatus 50 and a tree-structured document receiving apparatus 60 described below represent an example of application of the present invention in which an object to be transmitted is a plurality of tree-structured documents. A tree-structured document storage means 21 is the same as the structure document storage means 21 in the tree-structured document transmitting apparatus 20 shown in FIG. 3 and stores a plurality of tree-structured documents. Document-by-document encoding means 51 are named encoding means in such a sense that they perform processing for generating a predetermined encoded signal. The same number of document-by-document encoding means 51 as the number of tree-structured documents to be presently transmitted is prepared. One of a plurality of tree-structured documents to be presently transmitted is assigned to each of the document-by-document encoding means 51.

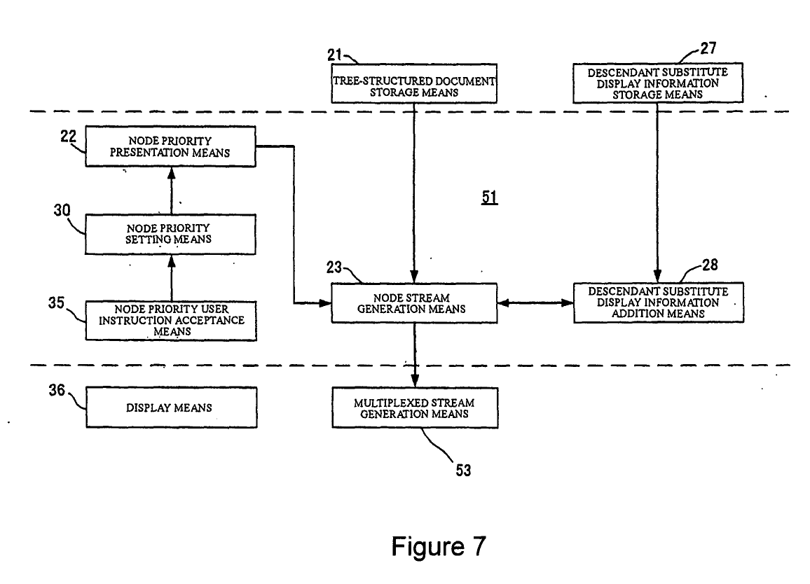

FIG. 7 is a detailed block diagram of the document-by-document encoding means 51. The document-by-document encoding means 51 may include a descendant substitute display information addition means 28, a node priority setting means 30, and a node priority user instruction acceptance means 35. A node priority presentation means 22, a node stream generation means 23, the substitute display information addition means 28, the node priority setting means 30, and a node priority user instruction acceptance means 35 are provided, which are the same as those described above with reference to FIGS. 3 and 4. The node stream generation means 23 in each document-by-document encoding means 51 reads out from the tree-structured document storage means 21 a tree-structured document assigned to it and generates a node stream in which nodes and/or subtrees are arranged in a sequence on the basis of node priorities presented by the node priority presentation means 22.

Referring to FIG. 6, an inter-document priority presentation means 52 presents inter-document priorities which are set as transmission priorities with respect to a plurality of tree-structured documents to be transmitted. Typically, inter-document priorities are set among a plurality of tree-structured documents to be transmitted on the basis of relative importance of each tree-structured document provided as information to be presented to a receiving-side user, as are node priorities. A multiplexed stream generation means 53 generates one multiplexed stream by multiplexing node streams from the document-by-document encoding means 51. In the multiplexed stream, the sequences in which the nodes and/or subtrees of the tree-structured documents are arranged are placed according to inter-document priorities presented by the inter-document priority presentation means 52 with respect to the tree-structured documents containing the nodes and/or subtrees. It is preferable that, to enable the multiplexed stream generation means 53 to recognize to which tree-structured document the nodes and/or subtrees from each node stream generation means 23 are related, the ID of the tree-structured document to which the nodes and/or subtrees transmitted from the node stream generation means 23 to the multiplexed stream generation means 53 belong be added to the nodes and/or subtrees. The transmitting means 54 transmits the multiplexed stream by converting the same on the basis of a predetermined network protocol.

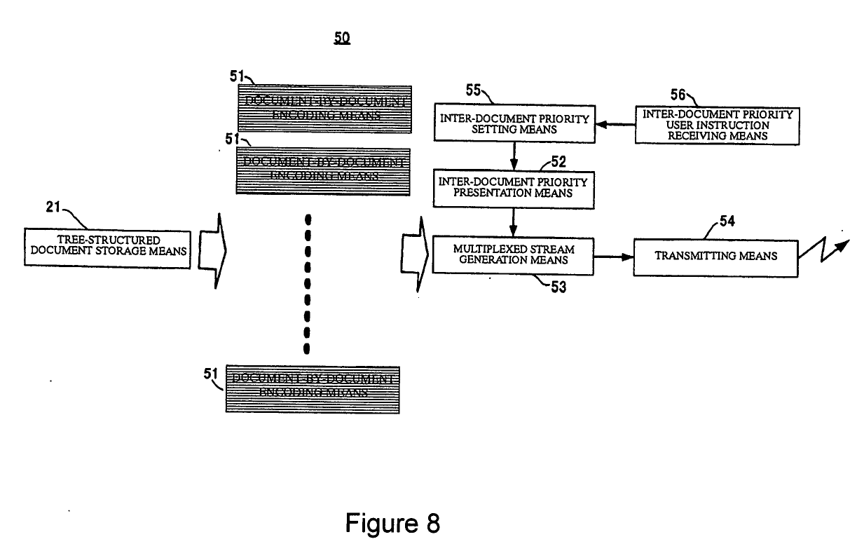

FIG. 8 is a block diagram of a tree-structured document transmitting apparatus 50 having several functions in addition to the functions corresponding to those of the tree-structured document transmitting apparatus 50 shown in FIG. 6. Description will be given of the additional functions. The inter-document priority presentation means 52 presents inter-document priorities set by an inter-document priority setting means 55. In a case where a plurality of tree-structured documents to be transmitted are tree-structured documents as a result of search according to a search request from a receiving-side user, the inter-document priority setting means 55 sets inter-document priorities with respect to the plurality of tree-structured documents to be transmitted on the basis of a sequence of the degrees of relation with a search word. The tree-structured document transmitting apparatus 50 has an inter-document priority user instruction receiving means 56 which receives a user instruction relating to an inter-document priority setting with respect to a plurality of tree-structured documents to be presently transmitted. The inter-document priority setting means 55 also sets inter-document priorities with respect to the plurality of tree-structured documents to be transmitted on the basis of a user instruction received by the inter-document priority user instruction receiving means 56. Further, the inter-document priority setting means 55 may set inter-document priorities on the basis of the contents and attributes of documents. For example, it is possible to balance the rates of advancement of transmission of documents by transmitting those larger in document size with priority.

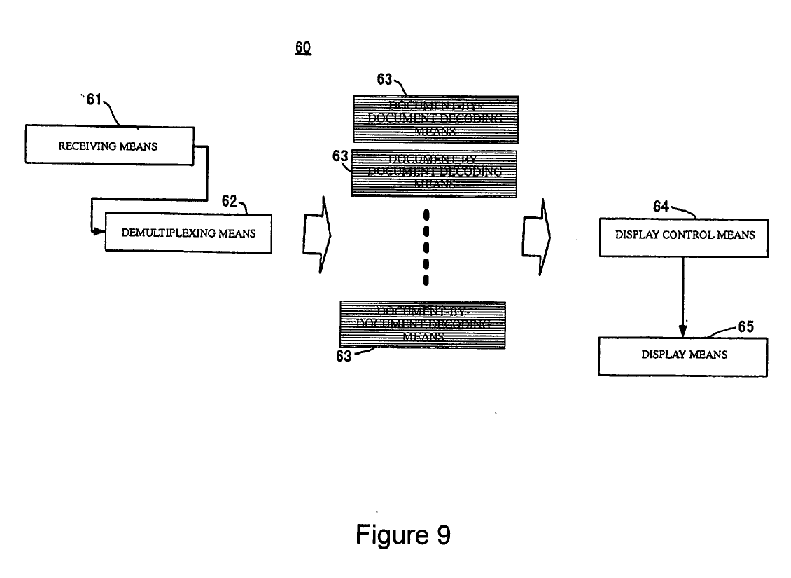

FIG. 9 is a block diagram of the tree-structured document receiving apparatus 60. The tree-structured document receiving apparatus 60 shown in FIG. 9 receives a multiplexed stream from the tree-structured document transmitting apparatus 50 shown in FIG. 6. A receiving means 61 restores the multiplexed stream from a signal received by a predetermined network protocol from the transmitting means 54. A demultiplexing means 62 demultiplexes the multiplexed stream into a plurality of node streams contained in the multiplexed stream.

Document-by-document decoding means 63 are named decoding means as means for performing processing reverse to the encoding processing performed by the document-by-document encoding means 51 shown in FIG. 6. To each document-by-document decoding means 63, one of the plurality of node streams formed by the demultiplexing means 62 is assigned as a node stream to be processed. Each document-by-document decoding means 63 includes an extraction means 42 (FIG. 5) and a reconstruction means 43 (FIG. 5). The function of the extraction means 42 is to extract, from a node stream to be processed, nodes and/or subtrees according to the sequence of arrangement in the node stream, as already described with reference to FIG. 5. The function of the reconstruction means 43 is to add nodes and/or subtrees in extraction order to a tree-structured document under reconstruction, as already described with reference to FIG. 5. A display control means 64 performs control such that a tree-structured document under reconstruction in each document-by-document decoding means 63 is displayed in the current reconstructed state on the display means 65, and also performs control such that each tree-structured document under reconstruction is displayed at a corresponding position on the display means 65.

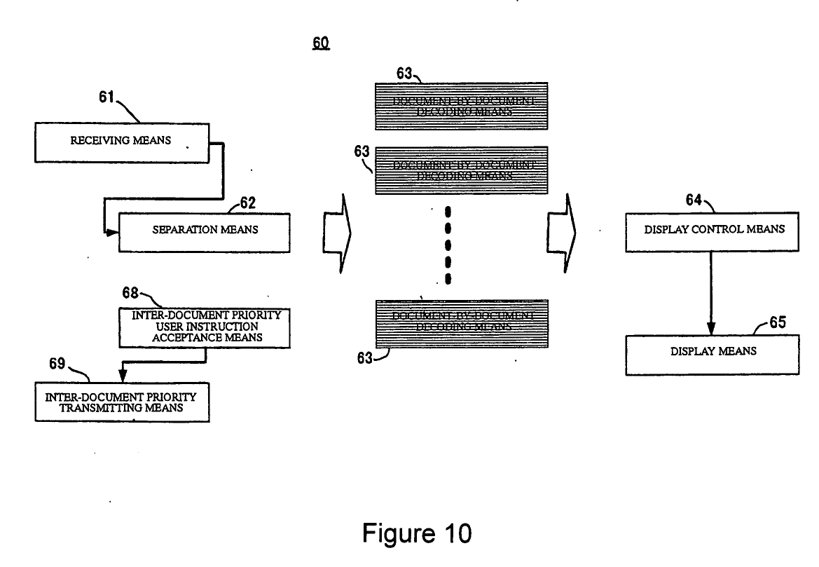

FIG. 10 is a block diagram of a tree-structured document receiving apparatus 60 having several functions in addition to the functions corresponding to those of the tree-structured document receiving apparatus 60 shown in FIG. 9. The tree-structured document receiving apparatus 60 shown in FIG. 10 is compatible with the tree-structured document transmitting apparatus 50 shown in FIG. 8. Description will be given only of the additional functions. An inter-document priority user instruction acceptance means 68 accepts a user instruction relating to an inter-document priority setting with respect to a plurality of tree-structured documents to be transmitted. An inter-document priority transmitting means 69 transmits the user instruction accepted by the inter-document priority user instruction acceptance means 68 to the inter-document priority user instruction receiving means 56 in the tree-structured document transmitting apparatus 50 via the network 12. User instructions accepted by the inter-document priority user instruction acceptance means 68 include an instruction to stop transmission of a specified tree-structured document when the document is being transmitted, an instruction to heighten the transmission priority of a specified tree-structured document relative to those of other tree-structured documents when the documents are being transmitted, and/or an instruction to stop transmission of all tree-structured documents other than a specified tree-structured document when the documents are being transmitted.

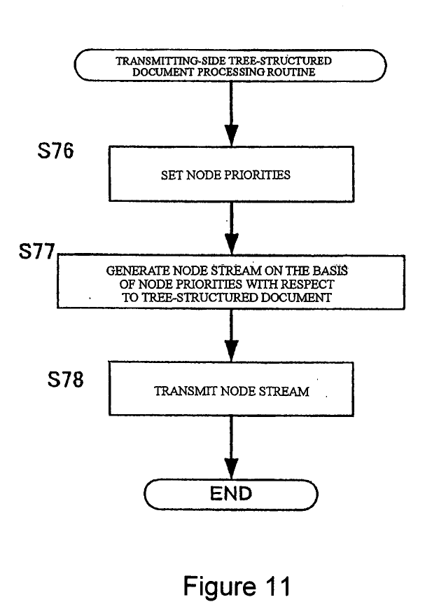

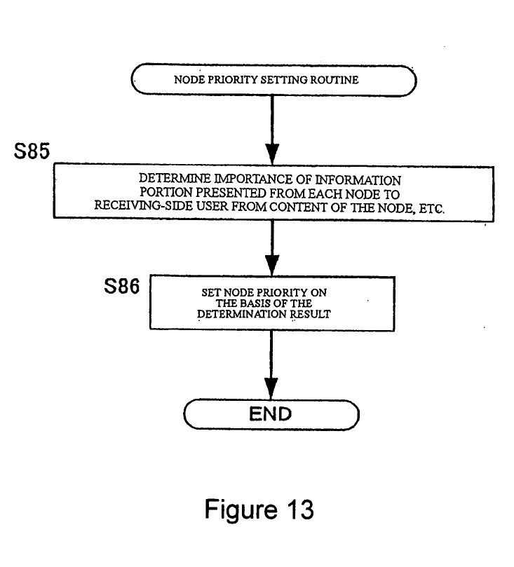

FIG. 11 is a flowchart of a tree-structured document transmitting routine in the tree-structured document transmitting and receiving system in which a single tree-structured document is processed. In S76, node priorities are read out. A concrete way to set node priorities will be described below with reference to FIG. 13. In step S77, a tree-structured document to be transmitted is read out from the tree-structured document storage means and a node stream is generated in which nodes and/or trees are arranged in a sequence on the basis of the node priorities set in the node priority setting step. In S78, the node stream is transmitted by being converted into a signal on the basis of a predetermined network protocol.

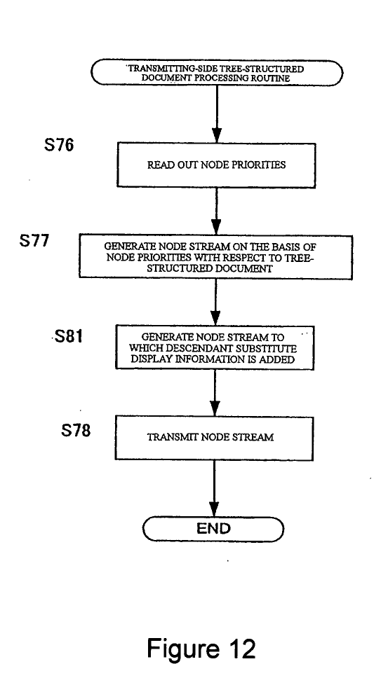

FIG. 12 shows a tree-structured document transmitting routine formed by adding a step to the tree-structured document transmitting routine shown in FIG. 11. S81 is inserted between S77 and S78. In S81, a stream in which descendant substitute display information for substitute display on the display means on the receiving side for descendant nodes related to a predetermined node and/or subtree existing as a parent of the descendant node is added immediately after the node and/or subtree existing as a parent of the descendant node is formed as a node stream. A single descendant node or a plurality of descendant nodes may be related to a descendant substitute display information item.

FIG. 13 is a flowchart for concretely explaining the node priority setting processing shown in FIG. 11. In S85, the importance of an information portion to be presented from each node of a tree-structured document to a receiving-side user is determined on the basis of a content of the node, an attribute of the node, a content of the document, an attribute of the document, the tree structure, a user instruction from a transmitting-side user, and/or a user instruction from the receiving-side user. The attribute of the node is, for example, a background color. If the background color is characteristic, it can be inferred that the information portion related to the node having the background color with respect to the entire document information is important to the receiving-side user. The user instruction from the transmitting-side user comprises, for example, an instruction for transmission of a transmission-prioritized node to be transmitted with priority according to transmitting-side user's need. The priority of nodes on the ancestor path from the node designated as a transmission-prioritized node by the transmitting-side user to a root node and the priority of nodes on any branch path branching from the ancestor path are heightened relative to the current priority. Also, the amount by which the priority of nodes on the ancestor path is heightened relative to the amount by which the priority of nodes on the branch path is heightened, and the amount by which the priority of nodes on the branch path is heightened in such a manner that the priority of one of the nodes closer to the branching point is higher than that of remoter ones. Node priorities are thus set. In S86, node priorities are set on the basis of the results of determination in S85. In node priority setting in S86, it is necessary to satisfy two conditions: the first condition that the node priority of each node of the tree-structured document is equal to or lower than that of the node existing as the ancestor of that node, and the second condition that if a plurality of nodes of the same priority exist, the nodes necessarily constitute one subtree.

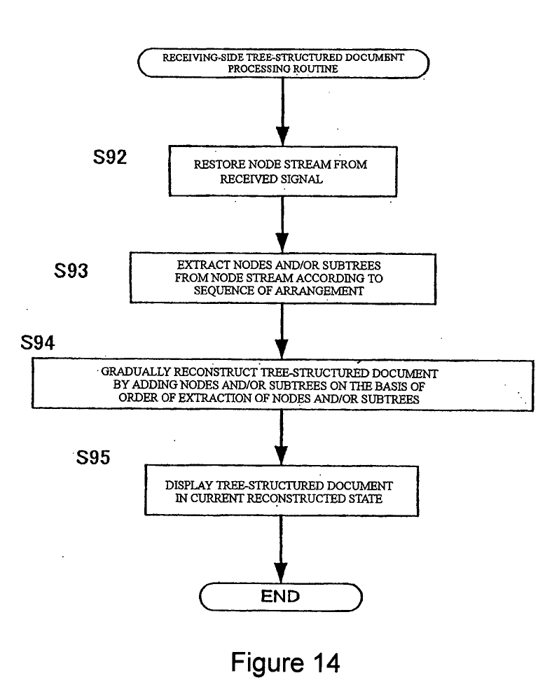

FIG. 14 is a flowchart of a tree-structured document receiving routine in the tree-structured document transmitting and receiving system in which a single tree-structured document is processed. The tree-structured document receiving routine shown in FIG. 14 is compatible with the tree-structured document transmitting routine shown in FIG. 11. In S92, a node stream is restored from a signal received by a predetermined network protocol. In S93, nodes and/or subtrees are extracted from the node stream restored in S92 according to the sequence of arrangement in the node stream. In S94, the extracted nodes and/or subtrees are added in the extraction order to a tree-structured document under reconstruction. In S95, the tree-structured document in the current reconstructed state is displayed on the display means.

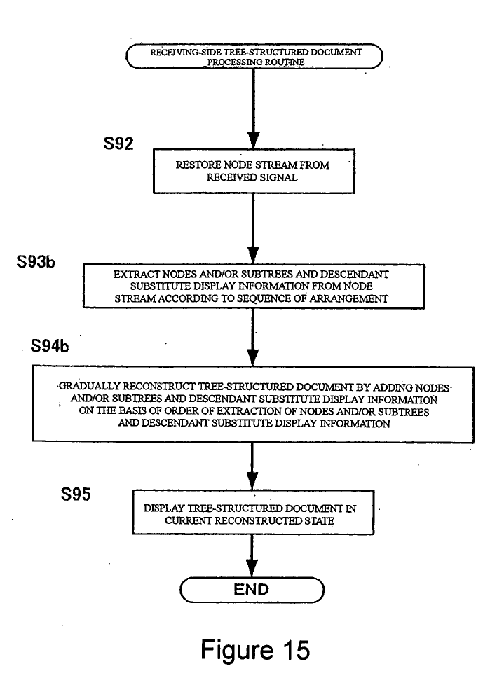

FIG. 15 is a flowchart of a tree-structured document receiving routine formed by changing part of the steps shown in FIG. 14. The tree-structured document receiving routine shown in FIG. 15 is compatible with the tree-structured document transmitting routine shown in FIG. 12. In S93b, nodes and/or subtrees and descendant substitute display information are extracted from the node stream restored in S92 according to the sequence of arrangement in the node stream. In S94b, when descendant substitute display information is extracted in S93b, a substitute structure portion relating to the descendant substitute display information is added to a tree structure under reconstruction in place of the descendant node relating to the descendant substitute display information. A display relating to the descendant substitute display information, provided as a display simplified relative to the display of the descendant node, is thereby produced on the display means 65 for a receiving-side user.

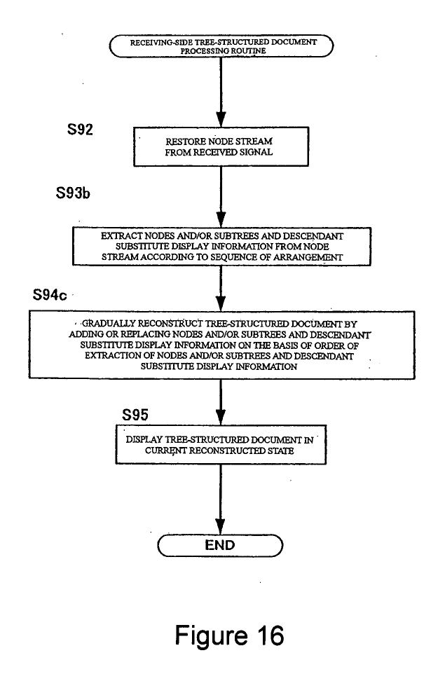

FIG. 16 is a flowchart of a tree-structured document receiving routine formed by changing part of the steps shown in FIG. 15. S94c includes, in addition to the processing in S94b, processing for immediately replacing the substitute tree-structured portion relating to the descendant substitute display information in the tree structure under reconstruction with the whole of the corresponding descendant node when the descendant node is extracted in S94b while the substitute display for the descendant node on the basis of the descendant substitute display information is being performed.

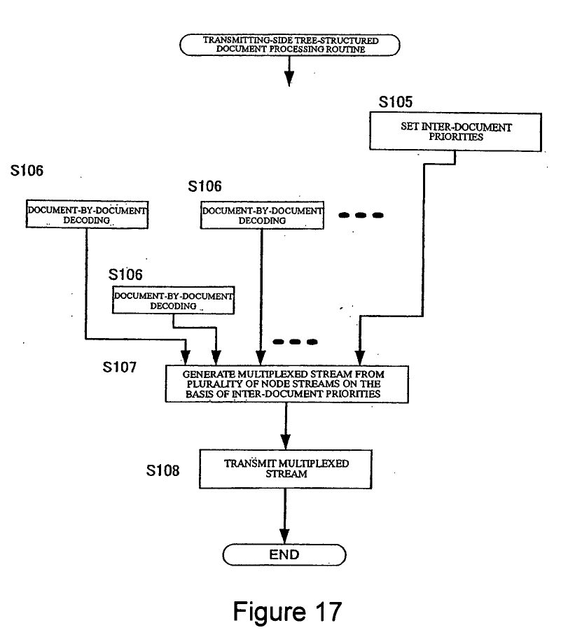

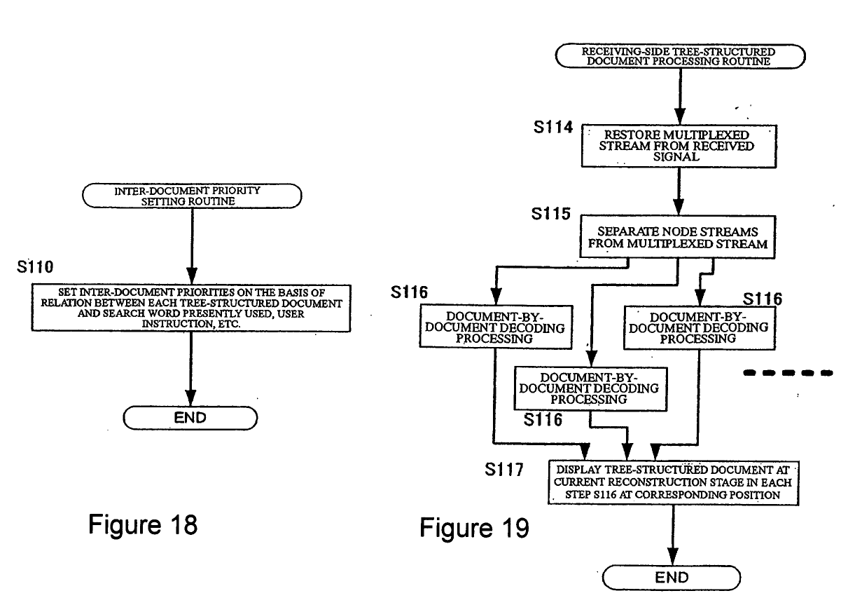

FIG. 17 is a flowchart of a tree-structured document transmitting routine in the tree-structured document transmitting and receiving system in which a plurality of tree-structured documents are processed. In S105, inter-document priorities are set. Details of S105 will be described below with reference to FIG. 18. The same number of processings corresponding to S106 as the number of tree-structured documents to be transmitted are prepared and executed in parallel with each other. Each processing corresponding to step S106 includes S76 and S77 in FIG. 11 or S76, S77 and S81 in FIG. 12. In S107, one multiplexed stream formed by multiplexing node streams generated in the processings corresponding to step S106 is restored. In the multiplexed stream, the sequences in which the nodes and/or subtrees of the tree-structured documents are arranged are formed as sequences according to the inter-document priorities set in S105 for the tree-structured document containing the node and/or partial tree. In S108, the multiplexed stream is transmitted by being converted on the basis of a predetermined network protocol.

FIG. 18 is a concrete flowchart of the processing in S105 shown in FIG. 17. In 5110, inter-document priorities are set on the basis of the degree of relation to a search word according to a search request from a receiving-side user, a user instruction from a transmitting-side user, and/or a user instruction from a receiving-side user, or other factors. The plurality of tree-structured documents to be transmitted may be tree-structured documents obtained as a result of a search based on a search request from a receiving-side user. In such a case, inter-document priorities are set according to the degree of relation to a search word relating to the search request from the receiving-side user. A user instruction relating to the inter-document priorities from the receiving-side user comprises, for example, an instruction to stop transmission of a specified tree-structured document when the document is being transmitted, an instruction to heighten the transmission priority of a specified tree-structured document relative to those of other tree-structured documents when the documents are being transmitted, and/or an instruction to stop transmission of all tree-structured documents other than a specified tree-structured document when the documents are being transmitted.

FIG. 19 is a flowchart of a tree-structured document receiving routine in the tree-structured document transmitting and receiving system in which a plurality of tree-structured documents are processed. This tree-structured document receiving routine is compatible with the tree-structured document transmitting routine shown in FIG. 17. In S114, a multiplexed stream is restored from a signal received by a predetermined network protocol. In S115, a multiplexed stream is demultiplexed into a plurality of node streams contained in the multiplexed stream. The same number of processings corresponding to S116 as the number of the node streams formed as a result of demultiplexing in S115 are prepared and executed in parallel with each other. To the processing corresponding to S116, one of the plurality of node streams restored in S115 is assigned as a node stream to be processed. Details of each processing corresponding to S115 are S93 and S94 in FIG. 14, S93b and S94b in FIG. 15, or S93b and S94c in FIG. 16. In S116, nodes and/or subtrees are extracted from the processed node stream according to the sequence of arrangement in the node stream (in correspondence with S93); nodes and/or subtrees and descendant substitute display information are extracted from the processed node stream according to the sequence of arrangement in the node stream (in correspondence with S93b) and the nodes and/or subtrees are added in the extraction order to a tree-structured document under reconstruction (in correspondence with S94); when descendant substitute display information is detected in S93b, the substitute structure portion relating to the descendant substitute display information is added to the tree structure under reconstruction in place of the descendant node relating to the descendant substitute display information (in correspondence with S94b); or, when the descendant node is detected in S93b while the substitute display for the descendant node is being performed on the basis of the descendant substitute display information, the substitute tree-structured portion relating to the descendant substitute display information in the tree structure under reconstruction is immediately replaced with the descendant node (in correspondence with S94c). In SI 17, the tree-structured document under reconstruction in the document-by-document decoding steps corresponding to S116 is displayed in the current reconstructed state on the display means 65.

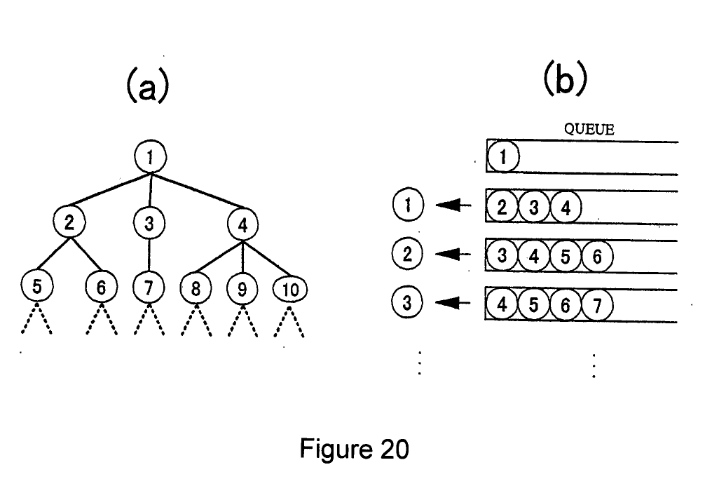

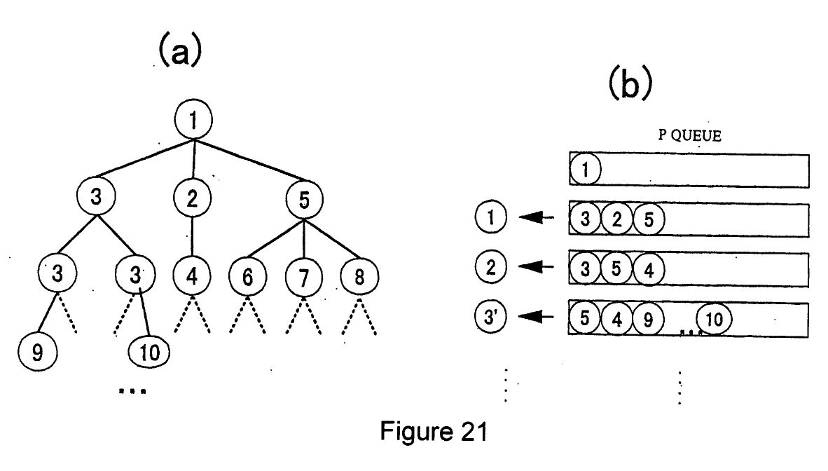

A node priority is set with respect to each node of a tree-structured document on the basis of the importance of an information portion to be presented from the node to a receiving-side user. The tree-structured document is transmitted by traversing and encoding the tree structure in the order according to the node priorities. FIGS. 20 and 21 respectively show a sequence in which nodes on a tree structure are searched in breadth-first search and a sequence in which nodes on the tree structure are searched in priority sequence search (search=traverse). According to the present invention, priority sequence search shown in FIG. 21 is used. In search shown in FIG. 20, a queue is used and the nodes are inserted in the queue in order from the root node. When each node is taken out from the queue, child nodes of the node taken out are newly inserted in the queue. FIG. 21 shows the search proposed according to the present invention. A queue using priorities (priority queue, hereinafter referred to as “P queue”) is used in place of a normal queue. Child nodes of a node taken out from the P queue are subsequently inserted in the P queue. In this respect, this search is the same as breadth-first search. From the P queue, however, nodes are taken out not in the order corresponding to the insertion order but in such a manner that one of the nodes having the highest priority is first taken out. While the unit handled in breadth-first search is consistently a node, the present invention allows coexistence of a case in which each of nodes taken out from the P queue is immediately encoded as a single node and a case in which several connected descendant nodes are collectively encoded. In FIG. 21, the expression of taking out of node 3 indicated by “3”′ denotes that not only node 3 but also a subtrees whose root corresponds to this node and which includes several connected descendant nodes are transmitted.

“Priority” refers to the degree of supposed effectiveness of faster arrival at the receiving side. Priorities are obtained in different concrete ways depending on applications. For example, priorities are obtained by a function of

the distance from the root node;

the existence/nonexistence of a characteristic attribute such as a background color;

the number of descendant nodes; and

the number of nodes having characteristic attributes in descendant nodes.

Further, priorities may be obtained by a function of, in addition to factors such as the above-mentioned ones determined from the structure and attributes of a document itself, factors according to user's preferences varying from user to user, e.g.,

the distance from a portion having a user-designated ID; and

the distance from a user-designated display position.

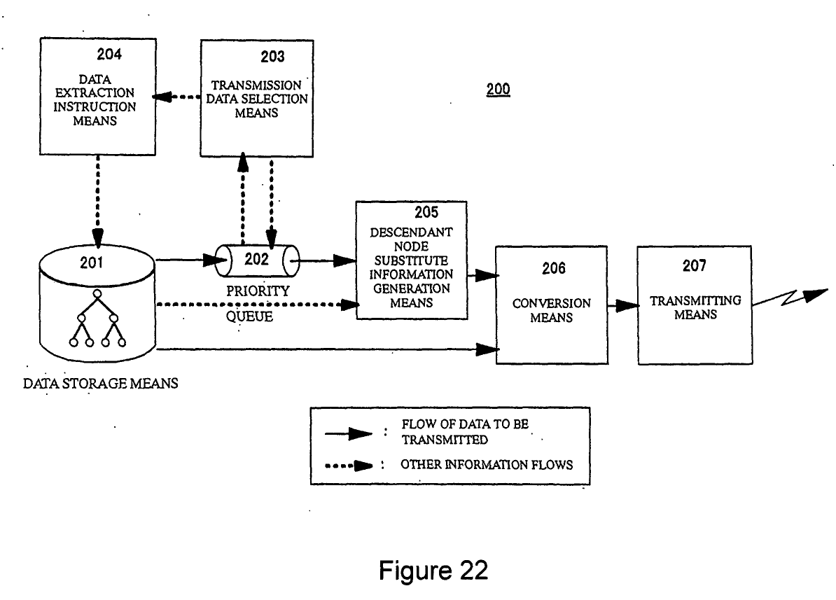

FIG. 22 is a block diagram of a transmitting apparatus 200. The correspondence relationship between the elements in FIG. 4 and the elements in FIG. 22 is as shown below.

Tree-structured document storage means 21: data storage means 201

Node priority presentation means 22: transmission data selection means 203

Node stream generation means 23: priority queue 202, transmission data selection means 203 and data extraction instruction means 204

Transmitting means 24: transmitting means 207

Descendant substitute display information addition means 28: descendant nodes substitute information generation means 205

Data to be transmitted is stored in the data storage means 201. A tree structure is sent from the data storage means 201 to the priority queue 202 on a node-by-bode basis according to an instruction from the data extraction instruction means 204. Each node is assigned a unique ID (e.g., a combination of an ID of a parent node and information indicating the ordinal position of the node in children of the parent node) to enable reconstruction on the tree structure on the receiving side. Information not belonging to the tree structure (e.g., style sheet information in an HTML document) is directly sent to a conversion means 206. The priority queue 202 is a P queue for realizing the above-described priority sequence search. A suitable node is sent from the priority queue 202 to the descendant nodes substitute information generation means 205 according to an instruction from the transmission data selection means 203. Not only a selected single node but also a subtree in a range following the selected node may be sent, as mentioned above. The transmission data selection means 203 computes priorities for the nodes in the priority queue 202 in accordance with predetermined rules and selects a node or subtree to be next transmitted. The data extraction instruction means 204 receives from the transmission data selection means 203 information as to “which node was taken out from the P queue” and “whether the node is a single node or a subtree accompanied with several descendant nodes”, and instructs the data storage means 201 to insert corresponding immediate child nodes in the P queue. If the data to be transmitted is a nonterminal node or a subtree and some descendant nodes not yet transmitted exist, the descendant nodes substitute information generation means 205 generates information such as to summarize the information on the descendant nodes by a small amount of data, and sends the generated information to the conversion means 206 together with the information sent from the priority queue 202. For example, if the tree-structured document is an HTML document, this information is the numbers of characters or the like contained in the descendent nodes. If the data to be transmitted is a leaf node or a subtree that has no descendant nodes to be transmitted, only the information sent from the priority queue 202 is sent to the conversion means 206. The conversion means 206 converts the information sent thereto to enable transmission of the information. The conversion means 206 may comprise a means for reversible compression using a well-known technique. Also, the conversion means 206 may have a buffer for improvement in efficiency. The transmitting means 207 transmits the converted information in accordance with a communication protocol. The transmitting means 207 may have a buffer for improvement in efficiency.

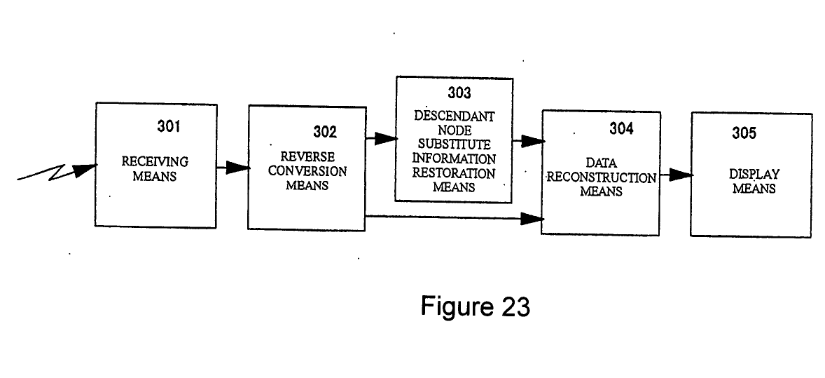

FIG. 23 is a block diagram of a receiving apparatus 300 compatible with the transmitting apparatus 200 shown in FIG. 22. The correspondence relationship between the elements in FIG. 5 and the elements in FIG. 23 is as shown below.

Receiving means 41: receiving means 301

Extraction means 42: descendant nodes substitute information restoration means 303 and data reconstruction unit 304

Reconstruction means 43: data reconstruction unit 304

Display means 44: display means 305

The receiving means 301 receives information based on the communication protocol. A reverse conversion means 302 restores to the original form the data converted by the conversion means 206 in the transmitting apparatus 200. If transmitted data is a portion of the tree structure, it is sent to the descendant nodes substitute information restoration means 303. If the transmitted data is data not belonging to the tree structure, it is sent to the data reconstruction unit 304. The descendant nodes substitute information restoration means 303 performs pseudo restoration of the descendant nodes relating to the nonterminal node presently subjected to processing on the basis of the information prepared by the descendant nodes substitute information generation means 205 on the transmitting side. The data reconstruction unit 304 reconstructs the tree structure and information accompanying the tree structure as much as possible on the basis of the information sent up to the present time. The display means 305 displays the data sent from the data reconstruction unit 304. The display means 305 may have a data storage function and other processing functions. Thus, the important portion of the tree structure can be first transmitted. Even at an intermediate stage of receiving on the receiving side, an outline can be displayed by using pseudo descendant nodes based on use of descendant nodes substitute information.

A system which enables browsing of a huge file (SVG, X3D or the like) formed as a tree-structured document will be described. In processing of such a huge file, the load defined as the amount of computation for preparing descendant nodes substitute information with respect to a nonterminal node is considered to be large. For this reason, suitable descendant nodes substitute information relating to nonterminal nodes are prepared and stored in advance. For example, with respect to each of <g> elements representing components or functional units in an SVG file representing design drawings of a complicated product, a <polygon> element representing a polygon having a dominant color in descendant nodes related to the <g> element and containing the area where the descendant nodes exist is prepared. That is, this polygon is displayed on the display means in the receiving apparatus by being substituted for the display of the plurality of descendant nodes. FIG. 24 is a diagram for explaining a node transmission sequence in a case where substitute display based on descendant nodes substitute information is performed on the display means in the receiving apparatus. FIG. 24(a) shows a portion of data to be transmitted. Numbers attached at upper left positions about the symbols for nodes represent a sequence in which the nodes in the illustrated region are transmitted according to priorities. It is assumed here that a <polygon> element representing descendant nodes substitute information with respect to node 3 is prepared. This <polygon> element is transmitted simultaneously with node 3. The amount of data of the <polygon> element is naturally smaller than the total amount of data of all the descendant nodes for which the <polygon> element is substituted and is, in fact, sufficiently small.

FIG. 24(b) shows the tree structure on the receiving side when node 3 is received and processed. The portion surrounded by the dotted line is collectively transmitted. From this <polygon> element, the outline of the figure shown by the descendant nodes related to node 3 can be grasped on the receiving side. FIG. 24(c) shows the tree structure on the receiving side when node 5 is received and processed. When a node existing as a true child of node 3 is received, the <polygon> element is discarded.

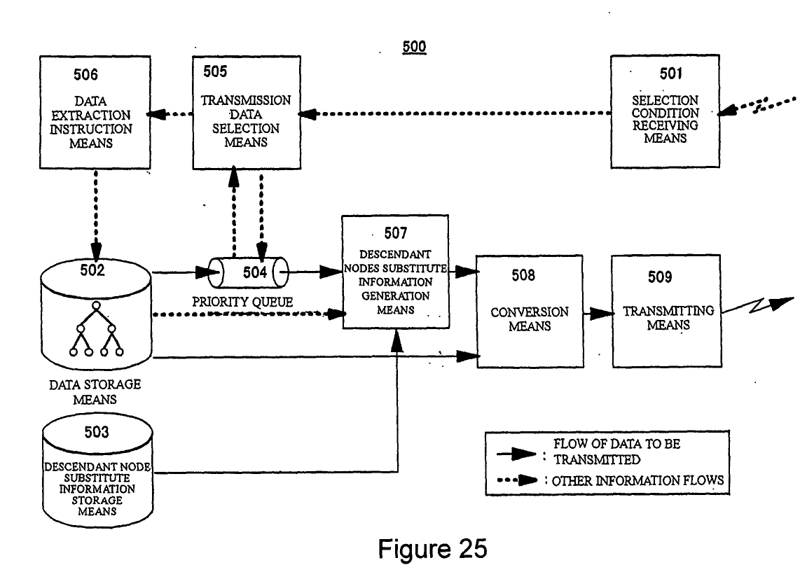

FIG. 25 is a block diagram of a transmitting apparatus 500 having the function of processing descendant nodes substitute information. The correspondence relationship between the elements in FIG. 4 and the elements in FIG. 25 is as shown below.

Tree-structured document storage means 21: data storage means 502

Node priority presentation means 22: transmission data selection means 505

Node stream generation means 23: priority queue 504, transmission data selection means 505 and data extraction instruction means 506

Transmitting means 24: transmitting means 509

Descendant substitute display information storage means 27: descendant nodes substitute information storage means 503

Descendant substitute display information addition means 28: descendant nodes substitute information generation means 507

Node priority setting means 30: transmission data selection means 505

Node priority user instruction receiving means 37: selection condition receiving means 501

The selection condition receiving means 501 receives an instruction from a user on the receiving apparatus side as to which portion in one file is to be received with priority. Examples of the user instruction are “to outline the whole and gradually detail the whole”, “to prioritize a portion at a center of the whole” and “to prioritize a node having an ID “engine”, descendants from the same and nodes about the same”. Data on tree-structured documents to be transmitted is stored in the data storage means 502. A specified tree-structured document is extracted from the data storage means 502 according to an instruction from the data extraction instruction means 506 and is sent on a node-by-node basis to the priority queue 504. Information not belonging to the tree structure is directly sent to a conversion means 508. The descendant nodes substitute information storage means 503 stores descendant nodes substitute information prepared with respect to predetermined nonterminal nodes. The descendant nodes substitute information storage means 503, which is considered to be also used as the data storage means 502 in actual use (for example, in one document database), is illustrated as a separate means to explicitly show the kind of data. The priority queue 504 is a P queue for realizing priority sequence search. A suitable node is sent from the priority queue 504 to the descendant nodes substitute information generation means 507 according to an instruction from the transmission data selection means 505. Not only a selected single node but also a subtree in a range following the selected node may be sent. The transmission data selection means 505 computes priorities for the nodes in the priority queue 504 in accordance with predetermined rules including a selection condition from the receiving apparatus side and selects a node or subtree to be next transmitted. The data extraction instruction means 506 receives from the transmission data selection means 505 information as to “which node was taken out from the P queue” and “whether the node is a single node or a subtree accompanied with several descendant nodes”, and instructs the data storage means 502 to insert corresponding child nodes in the P queue. If the data to be transmitted is a nonterminal node, the descendant nodes substitute information generation means 507 obtains from the descendant nodes substitute information storage means 503 information such as to summarize the information on the descendant nodes by a small amount of data, and sends this information to the conversion means 508 together with the information sent from the priority queue 504. If no descendant nodes substitute information can be used, the descendant nodes substitute information generation means 507 sends to the conversion means 508 only the information sent from the priority queue 504. The conversion means 508 converts the information sent thereto to enable transmission of the information. The conversion means 508 may have a buffer for improvement in efficiency. The transmitting means 509 transmits the coded information in accordance with a communication protocol. The transmitting means 509 may have a buffer for improvement of processing in efficiency.

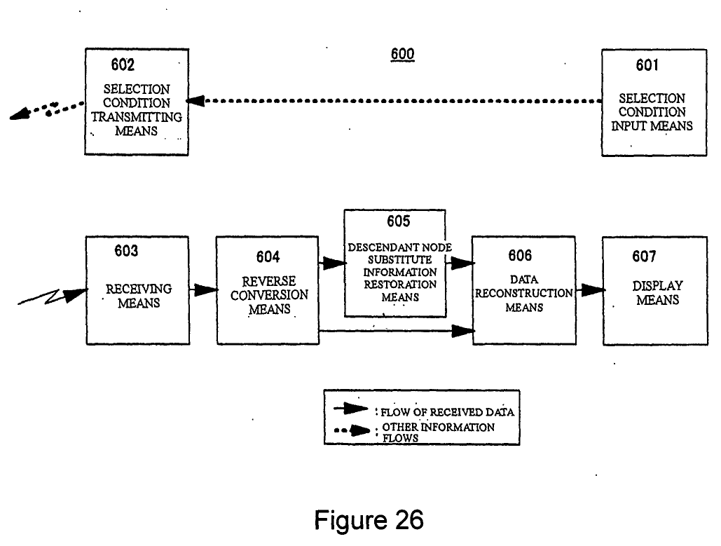

FIG. 26 is a block diagram of a receiving apparatus 600 which receives data from the transmitting apparatus 500 shown in FIG. 25. The correspondence relationship between the elements in FIG. 5 and the elements in FIG. 26 is as shown below.

Receiving means 41: receiving means 603

Extraction means 42: descendant nodes substitute information restoration means 605 and data reconstruction means 606

Reconstruction means 43: data reconstruction means 606

Display means 44: display means 607

Node priority user instruction acceptance means 46: selection condition input means 601

Node priority user instruction transmitting means 47: selection condition transmitting means 602

The receiving apparatus 600 has selection condition input means 601 provided as a user interface through which a user on the receiving apparatus side inputs a selection condition, and selection condition transmitting means 602 for transmitting the selection condition. The functions of the means from the receiving means 603 to the display means 607 are the same as those of the means 301 to 305 shown in FIG. 23, and description for them will not be repeated.

A system such as a search system enabling a multiplicity of files to be simultaneously browsed will be described as Embodiment 3. To simultaneously communicate a plurality of files in a combined state, the files are multiplexed at a transmitting side and demultiplexed at a receiving side. For ease of description, it assumed here that data is transmitted in one stream. However, the system can easily be expanded to transmit data in several streams. In either case, the system is designed by assuming that a number of files larger than the number of streams formable at a time are transmitted.

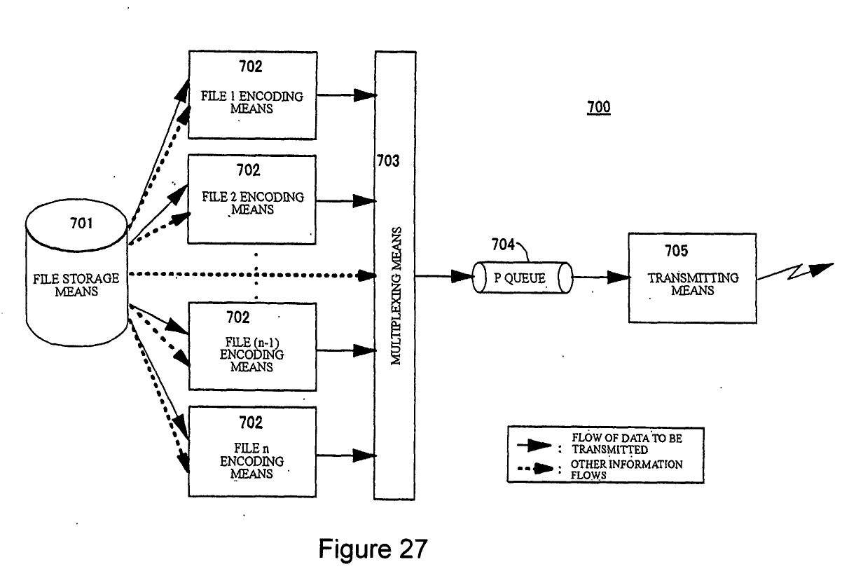

FIG. 27 is a block diagram of a transmitting apparatus 700 which simultaneously transmits a plurality of files together. The correspondence relationship between the elements in FIG. 6 and the elements in FIG. 27 is as shown below.

Tree-structured document storage means 21: file storage means 701

Document-by-document encoding means 51: file encoding means 702

Inter-document priority presentation means 52: multiplexing means 703

Multiplexed stream generation means 53: multiplexing means 703

Transmitting means 54: Transmitting means 705

Since the important point in this embodiment resides in encoding of files, the description of this embodiment will be made from a state where a plurality of files to be transmitted are collected at the file storage means 701, and the description of a portion corresponding to a search engine or the like in a search system, for example, is omitted. The file storage means 701 stores a plurality of files to be transmitted. For example, in the case of a search system, subinformation such as keywords used for search are stored in the file storage means 701. Each file is sent to one encoding means 702 together with subinformation. Further, if information about the differences between the degrees of importance between a plurality of files, e.g., “the degrees of relation to a keyword” in the search system exist, it is sent to the multiplexing means 703. Each file encoding means 702 incorporates the above-described transmitting apparatus 200. However, each file encoding means 702 does not include the transmitting means 207 in the transmitting apparatus 200. The file encoding means 702 performs encoding by computing priorities on the basis of subinformation sent from the file storage means 701. Encoding referred to here is outputting a stream of nodes and/or subtrees in a tree-structured document in the order according to priorities assigned to the nodes and/or subtrees. The file encoding means 702 produces output items on a node-by-node or subtree-by-subtree basis, which are successively sent to the multiplexing means 703 while being assigned a file ID for identification of the file. If the file encoding means 702 are realized in software form, the system can be made flexibly adaptable with respect to changes in the number of files to be processed. The multiplexing means 703 adds inter-file priorities to inputs from the plurality of file encoding means and sends them to the P queue 704. Inter-file priorities are provided for the purpose of comparing the degrees of supposed effectiveness of faster arrival at the receiving side between different files, and are each obtained by a function of the following factors:

the time of arrival at the multiplexing means;

information given from the file storage means 701 (such as the degree of relation to a keyword);

the position in the file (such as the distance from the root node); and

the priority in the file given from the corresponding encoder.

The P queue 704 is a P queue based on inter-file priorities. The transmitting means 705 takes out the elements from the P queue 704 in decreasing file-first order, and transmits the elements taken out.

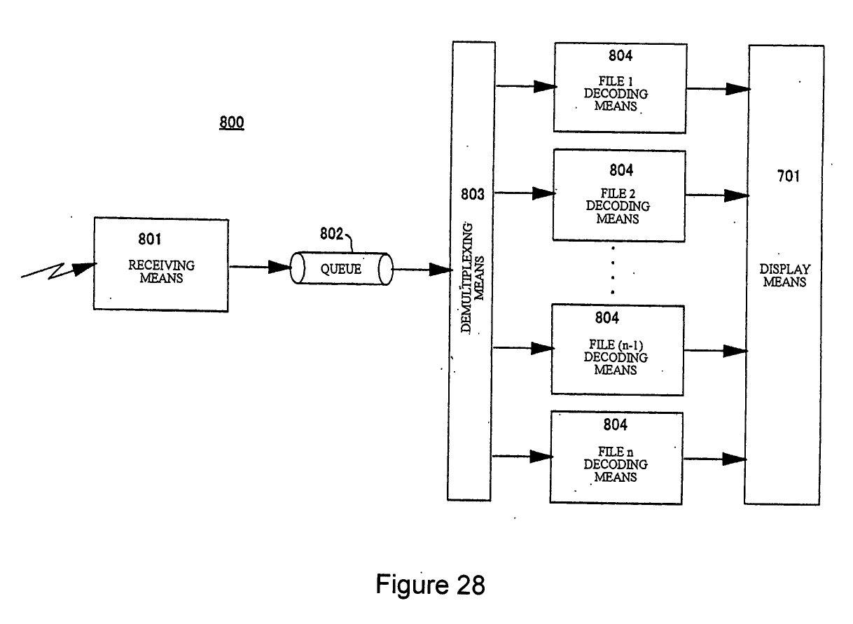

FIG. 28 is a block diagram of a receiving apparatus 800 which receives data from the transmitting apparatus 700 shown in FIG. 27. The correspondence relationship between the elements in FIG. 9 and the elements in FIG. 28 is as shown below.

Receiving means 61: receiving means 801

Demultiplexing means 62: demultiplexing means 803

Document-by-document decoding means 63: file decoding means 804

Display control means 64: file decoding means 804

Display means 65: display means 701

The receiving means 801 receives encoded data on a plurality of files sent from the transmitting side and inserts the data in the queue 802. The queue 802 is a first-in first-out queue. The queue 802 sends data items one by one to the demultiplexing means 803 while suitably arranging the data items. The demultiplexing means 803 recognizes each file ID of the encoded data sent to it, and sends the data to the predetermined file decoding means 804 according to the file ID. The file decoding means 804 incorporates the above-described receiving apparatus 300. Each file decoding means 804 decodes one file. Decoding referred to here is reconstructing the tree structure by receiving the in-stream nodes and/or subtrees in order (in the order according to the priorities set for the nodes and/or subtrees) from each of the streams for the tree-structured documents. The file decoding means 804 does not have the receiving means 301 and the display means 305 shown in FIG. 23. The file decoding means 804 reconstructs and updates the tree structure each time it receives the input fragment. Each time the file decoding means 804 updates the tree structure, or periodically, it sends the tree structure to the display means 805 at the corresponding point in time. If the file decoding means 804 are realized in software form, the system can be made flexibly adaptable with respect to changes in the number of files to be processed. The display means 805 receives the file from each file decoding means and displays the file.

Embodiment 4 is developed from Embodiments 2 and 3 as an application to an SFA support system. SFA (Sales Force Automation) refers in a broad sense to utilization of information technology by sales departments, sales persons or the like, i.e., points of immediate contact with clients, in companies, etc., and in a narrow sense to a scheme to improve the efficiency of sales activities by combining an intracorporate intranet and portable information terminals such as laptop personal computers, particularly using the Internet. This embodiment will be described with respect to use of an SVG file as tree-structured data. SVG is a kind of XML and a data format for expressing graphics, standardized by W3C (World Wide Web Consortium). SVG is not suitable for immediate expression of a raster image such as a photograph but suitable for display of vector graphics such as catalogs, presentation data (Microsoft PowerPoint, Lotus Freelance, etc.), CAD data, map data, and organization charts. SVG is a file format expected to become widespread in future.

In IMT-2000 which is a current mobile communication standard, the maximum communication rate usable during moving is 384 kbps. This rate is not high enough to communicate a large graphics file. That is, it takes ten and several seconds to several minutes to transfer a file of several hundred kilobytes to several megabytes. In SFA, one of the keys to success is to get access from any place to an intra-company database according to the state of contact with a client. In ordinary cases, a multiplicity of unnecessary information items appear as a result of a search using a keyword or the like and it is necessary for a user to narrow down search results for necessary files through his/her eyes.

In the current communication environments, it is not virtually possible to use an SVG database by “searching” it because the time required for transmission of all of a plurality of files obtained as a result of search thereof may be several ten minutes. It is possible to devise a system in which the search accuracy is improved by using subinformation based on a text of a small data amount to reduce the frequency of appearance of unnecessary items. However, it is difficult to provide subinformation easy for any sales person to understand and adaptable in various situations.

This embodiment will be described with respect to the possibility of forming a system in which the results of search of an SVG database are transferred by a communication method in accordance with the present invention to effectively use the communication capacity and to enable necessary files to be checked “through the eyes”. In this system, a plurality of SVG files obtained as a search result are progressively displayed in parallel with each other. A user can understand the outline of each file at an intermediate stage of receiving and can send to the transmitting side information for selecting a file to be received with priority, an unnecessary file or a target file. It is possible to effectively use the communication capacity by assigning a priority to transfer of a file to be transferred with priority, stopping transfer of an unnecessary file or, when a target file is found, stopping transfer of other files.

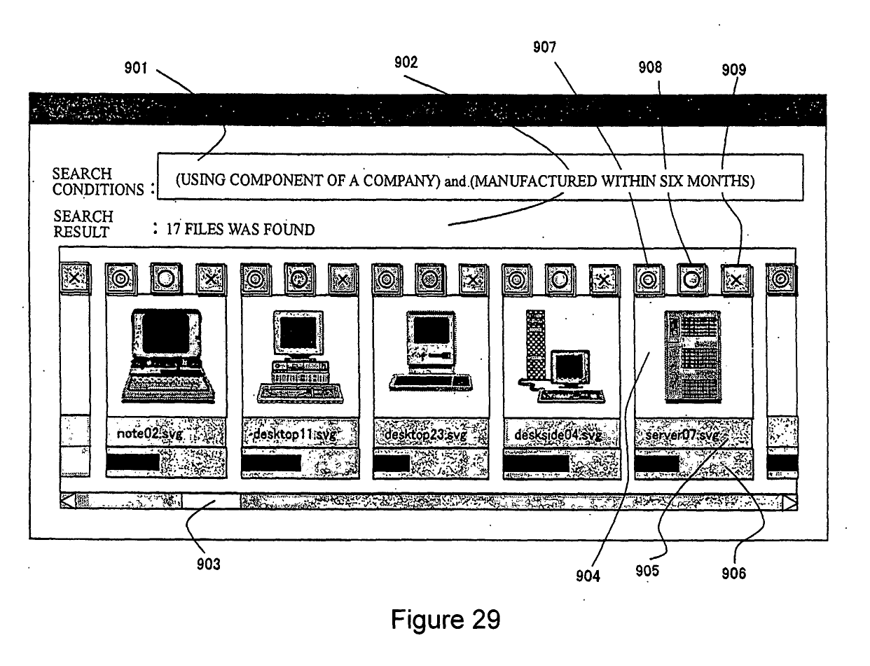

FIG. 29 shows an example of display on a window 900 on the receiving apparatus side (sales person use side) in a tree-structured document transmitting and receiving system arranged to enable a user on the receiving side to change inter-file priorities as desired while simultaneously receiving a plurality of files. Portions 904 to 909 are displayed with respect to each of search results. Conditions under which a search was made are displayed in a search condition display section 901. A search result is displayed in a search result display section 902. A scroll bar 903 is used to display a multiplicity of search results in a section of a restricted area in the window.

In each of file contents display regions 904, the contents of a file obtained as a search result are progressively displayed by the method in accordance with the present invention. In each of file name display regions 905, a file name in search results is displayed. In each of receiving rate display regions 906, the proportion of a received portion in the entire file volume is indicated with respect to each of search result files. A determination button 907 is pushed by the user during receiving when the user viewing the corresponding file content display region 904 recognizes that the file is the target file and the other files are unnecessary. By pushing the determination button 907, receiving of the other files is stopped and the entire communication capacity is assigned to the determined file. A priority button 908 is pushed by the user during receiving if the user viewing the corresponding file content display region 904 and receiving rate display region 906 wishes to increase the priority with which the file is received. If the priority button 908 is pushed, the corresponding file is received with priority over the other files. A stop button 909 is pushed by the user during receiving when the user viewing the corresponding file content display region 904 recognizes that the file is unnecessary. Receiving of this file is thereby stopped to enable the corresponding communication capacity to be distributed for receiving of the other files.

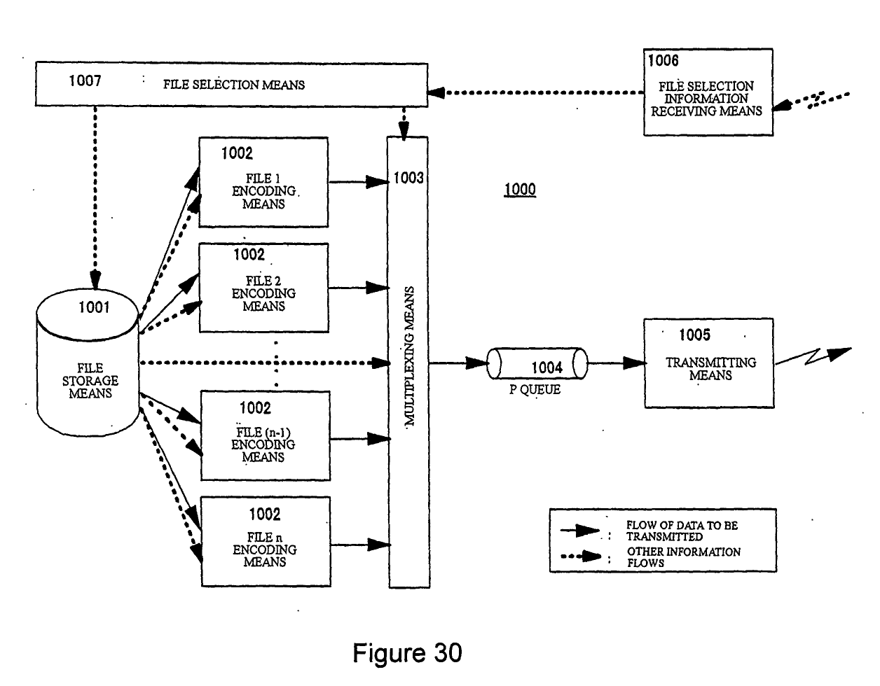

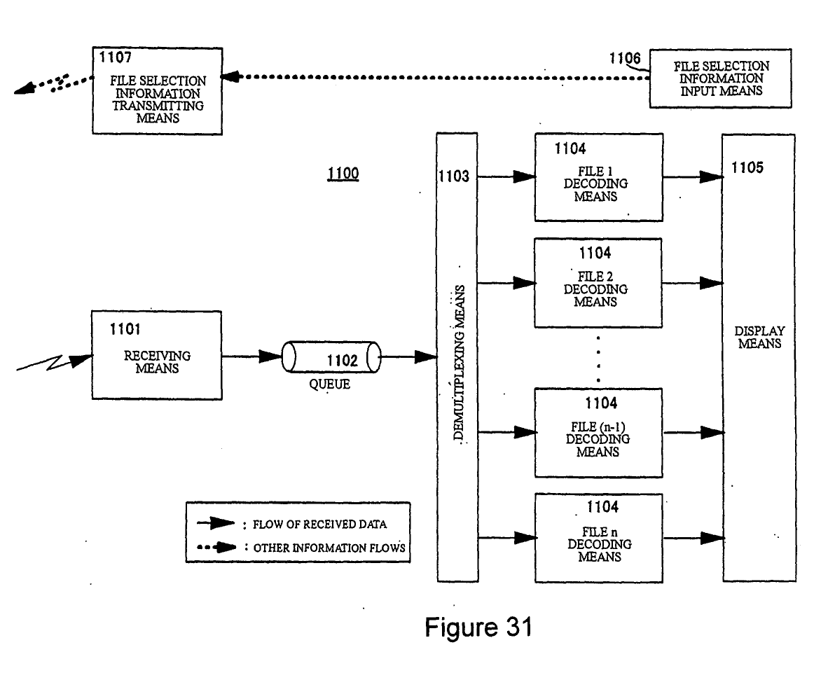

FIGS. 30 and 31 are block diagrams of a transmitting apparatus 1000 and a receiving apparatus 1100 for realizing operations performed by a receiving-side user using the window shown in FIG. 29.

The correspondence relationship between the elements in FIG. 8 and the elements in FIG. 30 is as shown below.

Tree-structured document storage means 21: file storage means 1001

Document-by-document encoding means 51: file encoding means 1002

Inter-document priority presentation means 52: file selection means 1007

Multiplexed stream generation means 53: multiplexing means 1003

Transmitting means 54: transmitting means 1005

Inter-document priority setting means 55: file selection means 1007

Inter-document priority user instruction receiving means 56: file selection information receiving means 1006

The correspondence relationship between the elements in FIG. 10 and the elements in FIG. 31 is as shown below.

Receiving means 61: receiving means 1101

Demultiplexing means 62: demultiplexing means 1103

Document-by-document decoding means 63: file decoding means 1104

Display control means 64: file decoding means 1104

Display means 65: display means 1105

Inter-document priority user instruction acceptance means 68: file selection information input means 1106

Inter-document priority transmitting means 69: file selection information transmitting means 1107

The basic form of the transmitting apparatus 1000 is the same as the configuration of the transmitting apparatus 700 (FIG. 27) in Embodiment 3. Also in the block diagram of the transmitting apparatus 1000, a portion corresponding to a search engine or the like in a search system is omitted. It is assumed that in the transmitting apparatus 1000 a plurality of files to be transmitted are collected at the file storage means 1001. The means 1001 to 1005 shown in FIG. 30 have the same functions as the means 701 to 705 shown in FIG. 27.

The file selection information receiving means 1006 receives information as to pushing of “determination button 907”, “priority button 908” and “stop button 909” shown in FIG. 29, and informs the file selection means 1007 of an identification of a file and a designation made with respect to the file. If the determination button related to a certain file is pushed, the file selection means 1007 informs the file storage means 1001 and the multiplexing means 1003 of the need to stop transmission of other files. If the priority button related to a certain file is pushed, the file selection means 1007 sends to that effect to the multiplexing means 1003 to increase the file-first of this file. If the stop button related to a certain file is pushed, the file selection means 1007 informs the file storage means 1001 and the multiplexing means 1003 of the need to stop transmission of the file.

The basic form of the receiving apparatus 1100 (FIG. 31) is the same as the configuration of the receiving apparatus 800 (FIG. 28) in Embodiment 3. The means 1101 to 1105 shown in FIG. 31 have the same functions as the means 801 to 805 shown in FIG. 28.

The file selection information input means 1106 monitors user operations and senses an operation of pushing any of “determination button 907”, “priority button 908” and “stop button 909” shown in FIG. 29, and sends to that effect to the file selection information transmitting means 1107. The file selection information transmitting means 1107 transmits to the file transmitting side (data base side) system information as to which button has been pressed in relation to which file.

In Embodiment 5, the present invention is applied to a remote electronic conference system or a CRM (Customer Relationship Management). In Embodiments 2 to 4, it is presupposed that at a transmitting side, which is a search system or a database, transmission is automatically performed at a request from a receiver side. In this embodiment, a user also exists at a transmitting side and the degree of priority is changed at a request at the transmitting side. Files are assumed to be SVG files. In an electronic conference, a pair of computers which transmit and receive tree-structured documents via a network are, in the system shown in FIG. 1, not a pair of the tree-structured document server 14 and one of PCs 16 but a pair of PCs 16. Each PC performs both the tree-structured document transmitting-side and receiving-side functions in an electronic conference.

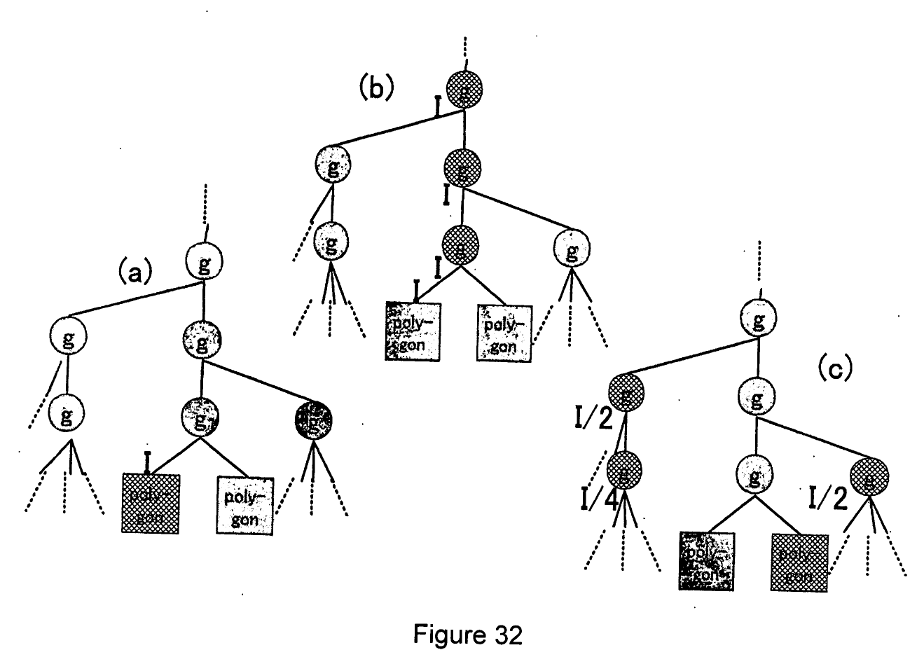

FIG. 32 is a tree structure diagram for explaining a change in priority made by a transmitting-side user. While “polygon” entered in FIG. 24 is described as information of substitute display for a plurality of descendant nodes on the receiving side, “polygon” entered in FIG. 32 represents a polygon corresponding to a particular portion of a product. In the case of “polygon” in FIG. 32, a content of a leaf node itself is a polygon. This SVG file is displayed on the transmitter side and the transmitter side user points and clicks, by a mouse cursor or the like, a portion which the user wishes to transmit with priority. First, a constant I is added to the priority of a lowermost-layer element pointed (FIG. 32(a)). The pointed element is shown as a double-hatched portion in FIG. 32(a). Next, the tree structure is traced from this element in the ancestor direction and the constant I is also added to the priorities of all the nodes (double-hatched nodes) on the route to the root node (FIG. 32(b)). Finally, the tree structure is traced from top to down and the priority of the node n generations down from each of the nodes on the ancestor node with the priority to which the constant I has been added is increased by (I/2n) (FIG. 32(c)). By using this algorithm, higher priorities can be given to the pointed portion and peripheral portions about the pointed portion.

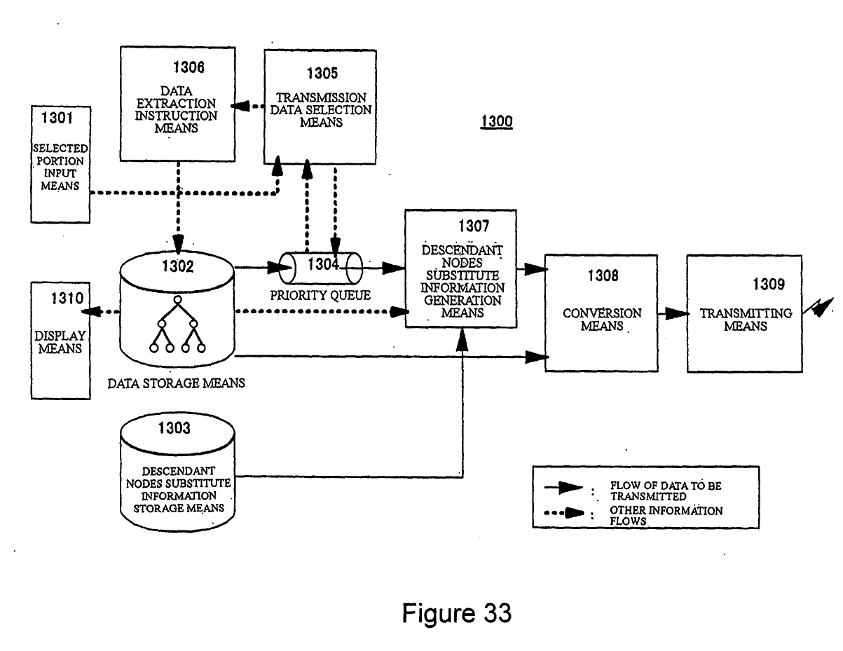

FIG. 33 is a block diagram of a transmitting apparatus 1300 having the function of changing priorities by an operation performed by a transmitting-side user in a tree-structured document transmitting and receiving system. The basic configuration of the transmitting apparatus 1300 is the same as that in Embodiment 2 shown in FIG. 25. The means 1302 to 1309 shown in FIG. 33 have the same functions as the means 502 to 509 shown in FIG. 25. Therefore, description for them will not be repeated. The correspondence relationship between the elements in FIG. 4 and the elements in FIG. 33 is as shown below.

Tree-structured document storage means 21: data storage means 1302

Node priority presentation means 22: transmission data selection means 1305

Node stream generation means 23: priority queue 1304, transmission data selection means 1305 and data extraction instruction means 1306

Transmitting means 24: transmitting means 1309

Descendant substitute display information storage means 27: descendant nodes substitute information storage means 1303

Descendant substitute display information addition means 28: descendant nodes substitute information generation means 1307

Node priority setting means 30: transmission data selection means 1305

Node priority user instruction acceptance means 35: selected portion input means 1301

Display means 36: display means 1310

In the selected portion input means 1301, the transmitting-side user designates a portion which the user wishes to send with priority while viewing a display on the display apparatus 1310. This designation is transmitted to the transmission data selection means 1305. The display apparatus 1310 enables the transmitting-side user to view data which the user wishes to transmit. In embodiment 5, any special device is not required on the receiving side and the same apparatus as the receiving apparatus 300 described with reference to FIG. 23 can be used. This configuration ensures that even in a case where a long time is required for communication, e.g., in the case of sending of large-volume data in a mobile environment, a portion considered by a transmitter to be important and peripheral portions about it can be displayed earlier at the other end of a communication channel, thus realizing smooth communication.

According to Embodiments 1 to 4, the outline of a document forming a tree structure can become known in a shorter time and, therefore, the contents of the document can be grasped in a shorter time at an intermediate stage of communication (not through external information such as remarks but information based on the very contents of the file). In particular, in a case where a plurality of documents are handled, the documents can be “Simultaneously” viewed and each document can be “progressively” viewed. Therefore, the outlines of the all the documents can be grasped in a short time in comparison with the conventional “document-by-document” “sequential” techniques. This effect is markedly advantageous in a case where the communication channel is narrow in comparison with an amount of data to be transmitted, e.g., in the case of accessing a large database in a mobile environment.

Further, priorities with which data is transmitted are not fixed and a demand from a user (from the transmitting side or the receiving side) can be reflected in the priorities, thus enabling transmission according to any of user's needs varying from user to user and characteristics of users. Portions of a file in which a user is interested or portions which a user knows well may be first transmitted for user's faster understanding of the file, for example, as to whether the file is one which the user needs.

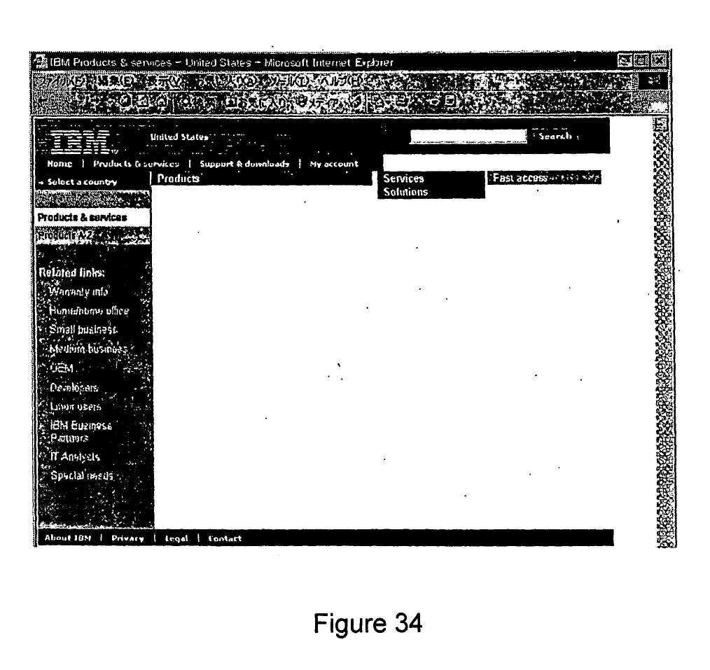

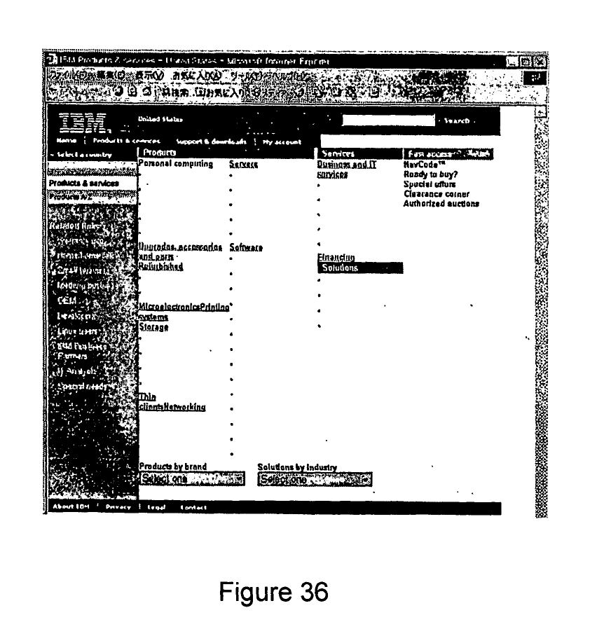

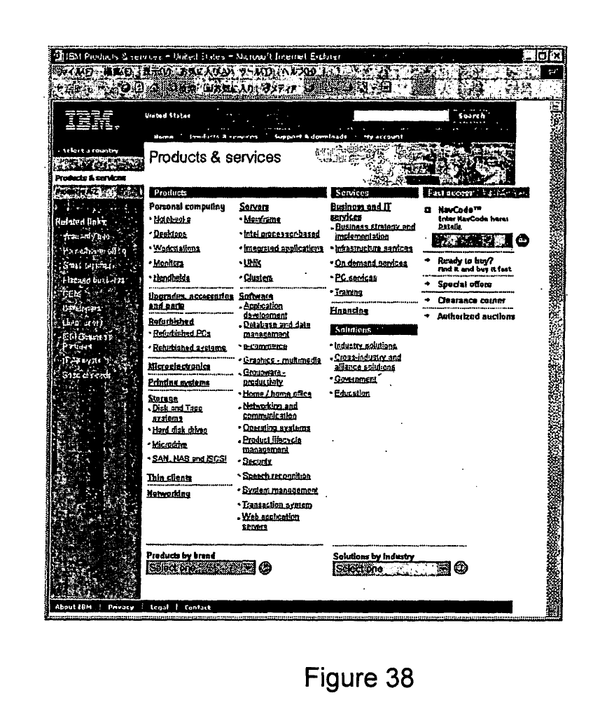

FIGS. 34 to 38 show examples of receiving-side on-screen images when an HTML document provided as a tree-structured document is processed in accordance with the present invention. In a client computer provided as a receiving apparatus, the Internet Explorer of Microsoft Corporation (trademark, hereinafter referred to as “IE”) is installed. A receiving-side user starts IE to download the HTML document from a predetermined server through IE. Images representing the HTML document progressive display process as shown in FIGS. 34 to 38 are formed on the basis of a home page of U.S. IBM Corporation. FIGS. 34 and 35 show examples of on-screen images at initial stages of downloading of the HTML document. FIGS. 36 and 37 show examples of on-screen images at intermediate stages of downloading of the HTML document. FIG. 38 shows an example of an on-screen image at a final stage of downloading of the HTML document. Each of the images shown in FIGS. 35 and 37 represents a state in which a node and substitute display information for descendant nodes relating to the node are sent from the server computer to the client computer. In this example, the descendant substitute display information is the sum of the numbers of characters of all the descendant nodes relating to each node. On the client computer, the number of characters “x” corresponding to the sum of the numbers of characters provided as descendant substitute display information are displayed at the descendant node display positions in the on-screen image. In contrast, in the case of the on-screen images shown in FIGS. 34 and 36, no descendant substitute display information is transmitted from the server computer and nothing is displayed as a display according to the descendant substitute display information.

In the HTML document in this description, node priorities are defined, for example, in order of (1) a node having a background color, (2) a node having itemized contents, (3) a node having a thick underline, (4) a form, (5) and the other nodes. In the on-screen images shown in FIGS. 34 and 35, a node (1) having a background color is received prior to nodes (2) to (5) by the client computer and displayed in the IE window. When the node having a background color and descendant substitute display information for descendant nodes related to the node having a background color are sent to the computer, a display according to the descendant substitute display information is made together with a display of the node having a background color in the IE window as shown in FIG. 35.

FIGS. 36 and 37 show states in which nodes to (4) are displayed by IE after being received by the client computer. When these nodes and descendant substitute display information for descendant nodes related to these nodes are transmitted to the client computer, a display according to the descendant substitute display information is made together with a display of the parent nodes relating to the descendant substitute display information in the IE window as shown in FIG. 37. When the descendant nodes are received by the client computer after the descendant substitute display has been made in the window, the descendant substitute display is replaced with the descendant nodes. The differences between the positions and the numbers of “x” in FIG. 35 and the positions and the numbers of “x” in FIG. 37 signify that the display based on the first-come descendant substitute display information is replaced with the nodes coming afterward, for which the substitute display based on the first-come descendant substitute display information has been made, and with the display based on the descendant substitute display information relating to these nodes.

While our invention has been described with respect to certain preferred embodiments and exemplifications, it is not intended to limit the scope of the invention thereby, but solely by the claims appended hereto.

1. A tree-structured document transmitting and receiving system having a tree-structured document transmitting apparatus and a tree-structured document receiving apparatus, said tree-structured document transmitting apparatus having:
tree-structured document storage means of storing a plurality of tree-structured documents;
node priority presentation means of presenting a node priority which is set with respect to each of nodes of a tree-structured document on the basis of the importance of an information portion to be presented from the node to a receiving-side user while satisfying two conditions: a first condition that the node priority of the node is equal to or lower than that of a node which is an ancestor of that node, and a second condition that if a plurality of nodes of the same priority exist, the nodes necessarily constitute one subtree;
node stream generation means of reading out a tree-structured document to be transmitted from the tree-structured document storage means and generating a node stream in which nodes and/or subtrees are arranged in a sequence on the basis of node priorities presented by said node priority presentation means; and
transmitting means of converting said node stream into a signal based on a predetermined network protocol and transmitting the signal, said tree-structured document receiving apparatus having:
receiving means of restoring the node stream from the signal received by said predetermined network protocol from said transmitting means;
extraction means of extracting the nodes and/or subtrees from the node stream restored by said receiving means according to the sequence of arrangement in the node stream;
reconstruction means of adding the nodes and/or subtree in the extraction order to the tree-structured document under reconstruction; and
display means of displaying the tree-structured document in the current reconstructed state.

2. The tree-structured document transmitting and receiving system according to claim 1, wherein said tree-structured document transmitting apparatus further has:
descendant substitute display information storage means of storing descendant substitute display information for substitute display on said display means of said tree-structured document receiving apparatus for descendant nodes with respect to a node and/or a subtree existing as a parent of the descendant node; and
descendant substitute display information addition means of making the node stream generation means generate as said node stream a stream in which the descendant substitute display information read out from said descendant substitute display information storage means is added immediately after the node and/or subtree existing as a parent of the descendant node, and
wherein, in said tree-structured document receiving apparatus, said extraction means extracts the nodes and/or subtrees and the descendant substitute display information from the node stream restored by said receiving means according to the sequence of arrangement in the node stream; and
said reconstruction means adds a substitute structure portion relating to the descendant substitute display information to the tree structure under reconstruction in place of the descendant node relating to the descendant substitute display information when said extraction means extracts the descendant substitute display information.

3. The tree-structured document transmitting and receiving system according to claim 2, wherein, in said tree-structured document receiving apparatus, said reconstruction means immediately replaces the substitute tree-structured portion relating to the descendant substitute display information in the tree structure under reconstruction with the descendant node when said extraction means extracts the descendant node while substitute display for the descendant node according to the descendant substitute display information is being performed.

4. The tree-structured document transmitting and receiving system according to claim 1, wherein said tree-structured document transmitting apparatus further has node priority setting means of determining the importance of an information portion to be presented from each node to the receiving-side user on the basis of a content of the node, an attribute of the node, a content of the document, an attribute of the document, the tree structure, a user instruction from a transmitting-side user, and/or a user instruction from the receiving-side user, and setting a node priority on the basis of the determination, and
wherein, in said tree-structured document transmitting apparatus, said node priority presentation means presents the node priority set by said node priority setting means.

5. A tree-structured document transmitting and receiving system having a tree-structured document transmitting apparatus and a tree-structured document receiving apparatus, said tree-structured document transmitting apparatus having:
tree-structured document storage means of storing a plurality of tree-structured documents;
a plurality of document-by-document encoding means each assigned processing of one tree-structured document in a plurality of tree-structured documents to be transmitted, and each having node priority presentation means and node stream generation means, said node priority presentation means presenting a node priority which is set with respect to each of nodes of said assigned tree-structured document on the basis of the importance of an information portion to be presented from the node to a receiving-side user while satisfying two conditions: a first condition that the node priority of the node is equal to or lower than that of a node which is an ancestor of that node, and a second condition that if a plurality of nodes of the same priority exist, the nodes necessarily constitute one subtree, said node stream generation means reading out a tree-structured document to be transmitted from the tree-structured document storage means and generating a node stream in which nodes and/or subtrees are arranged in a sequence on the basis of node priorities presented by said node priority presentation means;
inter-document priority presentation means of presenting inter-document priorities set as transmission priorities with respect to the plurality of tree-structured documents to be transmitted;
multiplexed stream generation means of generating one multiplexed stream by multiplexing the node streams from said document-by-document encoding means, sequences in which the nodes and/or subtrees of the tree-structured documents are arranged being placed in the multiplexed stream according to the inter-document priorities presented by said inter-document priority presentation means with respect to the tree-structured documents containing the nodes and/or subtrees; and
transmitting means of transmitting said multiplexed stream by converting said multiplexed stream on the basis of a predetermined network protocol, said tree-structured document receiving apparatus having:
receiving means of restoring the multiplexed stream from the signal received by said predetermined network protocol from said transmitting means;
demultiplexing means of demultiplexing the multiplexed stream into the plurality of node streams contained in the multiplexed stream;
a plurality of document-by-document decoding means each assigned processing of one node stream in the plurality of node streams demultiplexed by said demultiplexing means, and each including extraction means and reconstruction means, said extraction means extracting the nodes and/or subtrees from said processing-assigned node stream according to the sequence of arrangement in the node stream, said reconstruction means adding the nodes and/or subtree in the extraction order to the tree-structured document under reconstruction; and
display means of displaying the tree-structured document under reconstruction in each document-by-document decoding means, the tree structure being displayed in the current reconstructed state at a corresponding position.

6. The tree-structured document transmitting and receiving system according to claim 5, wherein, in said tree-structured document transmitting apparatus, said document-by-document encoding means further includes:
descendant substitute display information storage means of storing descendant substitute display information for substitute display on said display means of said tree-structured document receiving apparatus for descendant nodes with respect to a node and/or a subtree existing as a parent of the descendant node; and
descendant substitute display information addition means of making the node stream generation means generate as said node stream a stream in which the descendant substitute display information read out from said descendant substitute display information storage means is added immediately after the node and/or subtree existing as a parent of the descendant node, and
wherein, in each document-by-document decoding means of said tree-structured document receiving apparatus, said extraction means extracts the nodes and/or subtrees and the descendant substitute display information from the node stream restored by said receiving means according to the sequence of arrangement in the node stream; and
said reconstruction means adds a substitute structure portion relating to the descendant substitute display information to the tree structure under reconstruction in place of the descendant node relating to the descendant substitute display information when said extraction means extracts the descendant substitute display information.

7. The tree-structured document transmitting and receiving system according to claim 6, wherein, in each document-by-document decoding means of said tree-structured document receiving apparatus, said reconstruction means immediately replaces the substitute tree-structured portion relating to the descendant substitute display information in the tree structure under reconstruction with the descendant node when said extraction means extracts the descendant node while substitute display for the descendant node according to the descendant substitute display information is being performed.

8. The tree-structured document transmitting and receiving system according to claim 5, wherein the multiplexed stream generation means of said tree-structured document transmitting apparatus further has node priority setting means of determining the importance of an information portion to be presented from each node to the receiving-side user on the basis of a content of the node, an attribute of the node, a content of the document, an attribute of the document, the tree structure, and/or a user instruction, and setting a node priority on the basis of the determination, and
wherein, in the multiplexed stream generation means of said tree-structured document transmitting apparatus, said node priority presentation means presents the node priority set by said node priority setting means.

9. The tree-structured document transmitting and receiving system according to claim 5, wherein said tree-structured document transmitting apparatus further has inter-document priority setting means of setting inter-document priorities on the basis of the contents of the documents, the attributes of the documents, the degrees of relation with a search word relating to a search request from the receiving-side user, a user instruction from a transmitting-side user, and/or a user instruction from the receiving-side user, and
wherein, in said tree-structured document transmitting apparatus, said inter-document priority presentation means presents the inter-document priorities set by said inter-document priority setting means.

10. A tree-structured document transmitting apparatus having:
tree-structured document storage means of storing a plurality of tree-structured documents;
node priority presentation means of presenting a node priority which is set with respect to each of nodes of a tree-structured document on the basis of the importance of an information portion to be presented from the node to a receiving-side user while satisfying two conditions: a first condition that the node priority of the node is equal to or lower than that of a node which is an ancestor of that node, and a second condition that if a plurality of nodes of the same priority exist, the nodes necessarily constitute one subtree;
node stream generation means of reading out a tree-structured document to be transmitted from the tree-structured document storage means and generating a node stream in which nodes and/or subtrees are arranged in a sequence on the basis of node priorities presented by said node priority presentation means; and
transmitting means of converting said node stream into a signal based on a predetermined network protocol and transmitting the signal.

11. The tree-structured document transmitting apparatus according to claim 10, further having:
descendant substitute display information storage means of storing descendant substitute display information for substitute display on said display means of said tree-structured document receiving apparatus for descendant nodes with respect to a node and/or a subtree existing as a parent of the descendant node; and
descendant substitute display information addition means of making the node stream generation means generate as said node stream a stream in which the descendant substitute display information read out from said descendant substitute display information storage means is added immediately after the node and/or subtree existing as a parent of the descendant node.

12. The tree-structured document transmitting apparatus according to claim 10, further having:
node priority setting means of determining the importance of an information portion to be presented from each node to a receiving-side user on the basis of a content of the node, an attribute of the node, a content of the document, an attribute of the document, the tree structure, a user instruction from a transmitting-side user, and/or a user instruction from the receiving-side user, and setting a node priority on the basis of the determination,
wherein said node priority presentation means presents the node priority set by said node priority setting means.

13. A tree-structured document receiving apparatus which receives a signal formed by converting on the basis of a predetermined network protocol a node stream formed in such a manner that a node priority is set with respect to each of nodes of a tree-structured document on the basis of the importance of an information portion to be presented from the node to a receiving-side user while satisfying two conditions: a first condition that the node priority of the node is equal to or lower than that of a node which is an ancestor of that node, and a second condition that if a plurality of nodes of the same priority exist, the nodes necessarily constitute one subtree; and nodes and/or subtrees are arranged in a sequence on the basis of the node priorities, said tree-structured document receiving apparatus having:
receiving means of restoring the node stream from the signal received by the predetermined network protocol;
extraction means of extracting the nodes and/or subtrees from the node stream restored by said receiving means according to the sequence of arrangement in the node stream;
reconstruction means of adding the nodes and/or subtree in the extraction order to the tree-structured document under reconstruction; and
display means of displaying the tree-structured document in the current reconstructed state.

14. The tree-structured document receiving apparatus according to claim 13, wherein, in the node stream restored by said receiving means, descendant substitute display information for substitute display on said display means for descendant nodes with respect to a node and/or a subtree existing as a parent of the descendant node is added immediately after the node and/or subtree existing as a parent of the descendant node;
said extraction means extracts the nodes and/or subtrees and the descendant substitute display information from the node stream restored by said receiving means according to the sequence of arrangement in the node stream; and
said reconstruction means adds a substitute structure portion relating to the descendant substitute display information to the tree structure under reconstruction in place of the descendant node relating to the descendant substitute display information when said extraction means extracts the descendant substitute display information.

15. The tree-structured document receiving apparatus according to claim 14, wherein said reconstruction means immediately replaces the substitute tree-structured portion relating to the descendant substitute display information in the tree structure under reconstruction with the descendant node when said extraction means extracts the descendant node while substitute display for the descendant node according to the descendant substitute display information is being performed.

16. A tree-structured document transmitting apparatus having:
tree-structured document storage means of storing a plurality of tree-structured documents;
a plurality of document-by-document encoding means each assigned processing of one tree-structured document in a plurality of tree-structured documents to be transmitted, and each having node priority presentation means and node stream generation means, said node priority presentation means presenting a node priority which is set with respect to each of nodes of said assigned tree-structured document on the basis of the importance of an information portion to be presented from the node to a receiving-side user while satisfying two conditions: a first condition that the node priority of the node is equal to or lower than that of a node which is an ancestor of that node, and a second condition that if a plurality of nodes of the same priority exist, the nodes necessarily constitute one subtree, said node stream generation means reading out a tree-structured document to be transmitted from the tree-structured document storage means and generating a node stream in which nodes and/or subtrees are arranged in a sequence on the basis of node priorities presented by said node priority presentation means;
inter-document priority presentation means of presenting inter-document priorities set as transmission priorities with respect to the plurality of tree-structured documents to be transmitted;
multiplexed stream generation means of generating one multiplexed stream by multiplexing the node streams from said document-by-document encoding means, sequences in which the nodes and/or subtrees of the tree-structured documents are arranged being placed in the multiplexed stream according to the inter-document priorities presented by said inter-document priority presentation means with respect to the tree-structured documents containing the nodes and/or subtrees; and transmitting means of transmitting said multiplexed stream by converting said multiplexed stream on the basis of a predetermined network protocol.

17. The tree-structured document transmitting apparatus according to claim 16, wherein said document-by-document encoding means further includes:
descendant substitute display information storage means of storing descendant substitute display information for substitute display on said display means of said tree-structured document receiving apparatus for descendant nodes with respect to a node and/or a subtree existing as a parent of the descendant node; and
descendant substitute display information addition means of making the node stream generation means generate as said node stream a stream in which the descendant substitute display information read out from said descendant substitute display information storage means is added immediately after the node and/or subtree existing as a parent of the descendant node.

18. The tree-structured document transmitting apparatus according to claim 16, wherein the multiplexed stream generation means of said tree-structured document transmitting apparatus further has node priority setting means of determining the importance of an information portion to be presented from each node to the receiving-side user on the basis of a content of the node, an attribute of the node, a content of the document, an attribute of the document, the tree structure, and/or a user instruction, and setting a node priority on the basis of the determination, and
wherein, in the multiplexed stream generation means of said tree-structured document transmitting apparatus, said node priority presentation means presents the node priority set by said node priority setting means.

19. The tree-structured document transmitting apparatus according to claim 16, further having inter-document priority setting means of setting inter-document priorities on the basis of the contents of the documents, the attributes of the documents, the degrees of relation with a search word relating to a search request from the receiving-side user, a user instruction from a transmitting-side user, and/or a user instruction from the receiving-side user,
wherein said inter-document priority presentation means presents the inter-document priorities set by said inter-document priority setting means.

20. A tree-structured document receiving apparatus which receives a signal formed by converting on the basis of a predetermined network protocol a multiplexed stream formed in such a manner that a node priority is set with respect to each of nodes of a tree-structured document on the basis of the importance of an information portion to be presented from the node to a receiving-side user while satisfying two conditions: a first condition that the node priority of the node is equal to or lower than that of a node which is an ancestor of that node, and a second condition that if a plurality of nodes of the same priority exist, the nodes necessarily constitute one subtree; node streams are formed in each of which, with respect to one of a plurality of tree-structured documents to be presently transmitted, nodes and/or subtrees are arranged in a sequence on the basis of the node priorities related to the tree-structured document; and the multiplexed stream is formed by multiplexing the node streams relating to the tree-structured documents to be presently transmitted, sequences in which the nodes and/or subtrees of the tree-structured documents are arranged being placed in the multiplexed stream according to inter-document priorities set with respect to the tree-structured documents containing the nodes and/or subtrees, said tree-structured document receiving apparatus having:
receiving means of restoring the multiplexed stream from the signal received by the predetermined network protocol;
demultiplexing means of demultiplexing the multiplexed stream into the plurality of node streams contained in the multiplexed stream;
a plurality of document-by-document decoding means each assigned processing of one node stream in the plurality of node streams demultiplexed by said demultiplexing means, and each including extraction means and reconstruction means, said extraction means extracting the nodes and/or subtrees from said processing-assigned node stream according to the sequence of arrangement in the node stream, said reconstruction means adding the nodes and/or subtree in the extraction order to the tree-structured document under reconstruction; and
display means of displaying the tree-structured document under reconstruction in each document-by-document decoding means, the tree structure being displayed in the current reconstructed state at a corresponding position.

21. The tree-structured document receiving apparatus according to claim 20, wherein, in the node stream, descendant substitute display information for substitute display on said display means for descendant nodes with respect to a node and/or a subtree existing as a parent of the descendant node is added immediately after the node and/or subtree existing as a parent of the descendant node;
said extraction means in said document-by-document decoding means extracts the nodes and/or subtrees and the descendant substitute display information from the node stream according to the sequence of arrangement in the node stream; and
said reconstruction means in said document-by-document decoding means adds a substitute structure portion relating to the descendant substitute display information to the tree structure under reconstruction in place of the descendant node relating to the descendant substitute display information when said extraction means extracts the descendant substitute display information.

22. The tree-structured document receiving apparatus according to claim 21, wherein said reconstruction means in said document-by-document decoding means immediately replaces the substitute tree-structured portion relating to the descendant substitute display information in the tree structure under reconstruction with the descendant node when said extraction means extracts the descendant node while substitute display for the descendant node according to the descendant substitute display information is being performed.

23. A tree-structured document transmitting and receiving method having a tree-structured document transmitting method and a tree-structured document receiving method, said tree-structured document transmitting method having:
a node stream generation step of generating a node stream in such a manner that a node priority is set with respect to each of nodes of a tree-structured document on the basis of the importance of an information portion to be presented from the node to a receiving-side user while satisfying two conditions: a first condition that the node priority of the node is equal to or lower than that of a node which is an ancestor of that node, and a second condition that if a plurality of nodes of the same priority exist, the nodes necessarily constitute one subtree; a tree-structured document to be transmitted is read out from tree-structured document storage means; and nodes and/or subtrees of the tree-structured document are arranged in a sequence on the basis of said node priorities; and
a transmitting step of converting said node stream into a signal based on a predetermined network protocol and transmitting the signal, said tree-structured document receiving method having:
a receiving step of restoring the node stream from the signal received by said predetermined network protocol;
an extraction step of extracting the nodes and/or subtrees from the node stream restored in said receiving step according to the sequence of arrangement in the node stream;
a reconstruction step of adding the extracted nodes and/or subtree in the extraction order to the tree-structured document under reconstruction; and
a display step of displaying on the display means the tree-structured document in the current reconstructed state.

24. The tree-structured document transmitting and receiving method according to claim 23, wherein said tree-structured document transmitting method further has:
a descendant substitute display information addition step of generating, in the node stream generation step, as said node stream, a node stream in which descendant substitute display information for substitute display on display means on the receiving side for descendant nodes with respect to a node and/or a subtree existing as a parent of the descendant node is added immediately after the node and/or subtree existing as a parent of the descendant node, and
wherein, in said tree-structured document receiving method, said extraction step comprises extracting the nodes and/or subtrees and the descendant substitute display information from the node stream restored in said receiving step according to the sequence of arrangement in the node stream; and
said reconstruction step comprises adding a substitute structure portion relating to the descendant substitute display information to the tree structure under reconstruction in place of the descendant node relating to the descendant substitute display information when the descendant substitute display information is extracted in said extraction step.

25. The tree-structured document transmitting and receiving method according to claim 24, wherein, in said tree-structured document receiving method, said reconstruction step comprises immediately replacing the substitute tree-structured portion relating to the descendant substitute display information in the tree structure under reconstruction with the descendant node when the descendant node is extracted in said extraction step while substitute display for the descendant node according to the descendant substitute display information is being performed.

26. The tree-structured document transmitting and receiving method according to claim 23, wherein said tree-structured document transmitting method has a node priority setting step of setting node priorities used in the node stream generation step, and
wherein, in said node priority setting step, the importance of an information portion to be presented from each node to the receiving-side user is determined on the basis of a content of the node, an attribute of the node, a content of the document, an attribute of the document, the tree structure, a user instruction from a transmitting-side user, and/or a user instruction from the receiving-side user, and a node priority is set on the basis of the determination.

27. A tree-structured document transmitting and receiving method having a tree-structured document transmitting method and a tree-structured document receiving method, said tree-structured document transmitting method having:
a plurality of document-by-document encoding steps each assigned processing of one tree-structured document in a plurality of tree-structured documents to be transmitted, and each including a node stream generation substep comprising generating a node stream in such a manner that a node priority is set with respect to each of nodes of a tree-structured document on the basis of the importance of an information portion to be presented from the node to a receiving-side user while satisfying two conditions: a first condition that the node priority of the node is equal to or lower than that of a node which is an ancestor of that node, and a second condition that if a plurality of nodes of the same priority exist, the nodes necessarily constitute one subtree; one assigned tree-structured document is read out from tree-structured document storage means; and nodes and/or subtrees of the tree-structured document are arranged in a sequence on the basis of said node priorities;
a multiplexed stream generation step of generating one multiplexed stream by multiplexing the node streams in said document-by-document encoding steps, inter-document priorities being set as transmission priorities with respect to the plurality of tree-structured documents to be transmitted, sequences in which the nodes and/or subtrees of the tree-structured documents are arranged being placed in the multiplexed stream according to the inter-document priorities with respect to the tree-structured documents; and
a transmitting step of transmitting said multiplexed stream by converting said multiplexed stream on the basis of a predetermined network protocol, said tree-structured document receiving method having:
a receiving step of restoring the multiplexed stream from the signal received by the predetermined network protocol;
a demultiplexing step of demultiplexing the multiplexed stream into the plurality of node streams contained in the multiplexed stream;
a plurality of document-by-document decoding steps each assigned processing of one node stream in the plurality of node streams demultiplexed in said demultiplexing step, and each including an extraction substep and a reconstruction substep, said extraction substep comprising extracting the nodes and/or subtrees from said processing-assigned node stream according to the sequence of arrangement in the node stream, said reconstruction substep comprising adding the nodes and/or subtree extracted in said extraction substep in the extraction order to the tree-structured document under reconstruction; and
a display step of displaying the tree-structured document under reconstruction in each document-by-document decoding step, the tree structure being displayed in the current reconstructed state at a corresponding position of the display means.

28. The tree-structured document transmitting and receiving method according to claim 27, wherein, in said tree-structured document transmitting method, said document-by-document encoding step further includes:
a descendant substitute display information addition substep of generating, in the node stream generation step, as said node stream, a node stream in which descendant substitute display information for substitute display on display means on the receiving side for descendant nodes with respect to a node and/or a subtree existing as a parent of the descendant node is added immediately after the node and/or subtree existing as a parent of the descendant node, and
wherein, in said tree-structured document receiving method, said extraction substep in each document-by-document decoding step comprises extracting the nodes and/or subtrees and the descendant substitute display information from the node stream restored in said receiving step according to the sequence of arrangement in the node stream; and
said reconstruction substep in each document-by-document decoding step of said tree-structured document receiving method comprises adding a substitute structure portion relating to the descendant substitute display information to the tree structure under reconstruction in place of the descendant node relating to the descendant substitute display information when the descendant substitute display information is extracted in said extraction substep.

29. The tree-structured document transmitting and receiving method according to claim 28, wherein, in said tree-structured document receiving method, said reconstruction substep in each document-by-document decoding step comprises immediately replacing the substitute tree-structured portion relating to the descendant substitute display information in the tree structure under reconstruction with the descendant node when the descendant node is extracted in said extraction substep while substitute display for the descendant node according to the descendant substitute display information is being performed.

30. The tree-structured document transmitting and receiving method according to claim 27, wherein the multiplexed stream generation step of said tree-structured document transmitting method includes a node priority setting substep of setting node priorities used in the node stream generation substep, and
wherein, in said node priority setting substep, the importance of an information portion to be presented from each node to the receiving-side user is determined on the basis of a content of the node, an attribute of the node, a content of the document, an attribute of the document, the tree structure, and/or a user instruction, and a node priority is set on the basis of the determination.

31. The tree-structured document transmitting and receiving method according to claim 27, wherein said tree-structured document transmitting method further has an inter-document priority setting step of setting inter-document priorities on the basis of the contents of the documents, the attributes of the documents, the degrees of relation with a search word relating to a search request from the receiving-side user, a user instruction from a transmitting-side user, and/or a user instruction from the receiving-side user, and
wherein, in said tree-structured document transmitting method, said multiplexed stream generation step comprises restoring the multiplexed stream on the basis of the inter-document priorities set in said inter-document priority setting step.

32. A tree-structured document transmitting method having:
a plurality of document-by-document encoding steps each assigned processing of one tree-structured document in a plurality of tree-structured documents to be transmitted, and each including a node stream generation substep comprising generating a node stream in such a manner that a node priority is set with respect to each of nodes of a tree-structured document on the basis of the importance of an information portion to be presented from the node to a receiving-side user while satisfying two conditions: a first condition that the node priority of the node is equal to or lower than that of a node which is an ancestor of that node, and a second condition that if a plurality of nodes of the same priority exist, the nodes necessarily constitute one subtree; one assigned tree-structured document is read out from tree-structured document storage means; and
nodes and/or subtrees of the tree-structured document are arranged in a sequence on the basis of said node priorities;
a multiplexed stream generation step of generating one multiplexed stream by multiplexing the node streams in said document-by-document encoding steps, inter-document priorities being set as transmission priorities with respect to the plurality of tree-structured documents to be transmitted, sequences in which the nodes and/or subtrees of the tree-structured documents are arranged being placed in the multiplexed stream according to the inter-document priorities with respect to the tree-structured documents; and
a transmitting step of transmitting said multiplexed stream by converting said multiplexed stream on the basis of a predetermined network protocol.

33. The tree-structured document transmitting method, wherein the node stream generation substep in said document-by-document encoding step includes a descendant substitute display information addition substep of generating, in the node stream generation step, as said node stream, a stream in which descendant substitute display information for substitute display on display means on the receiving side for descendant nodes with respect to a node and/or a subtree existing as a parent of the descendant node is added immediately after the node and/or subtree existing as a parent of the descendant node.

34. The tree-structured document transmitting method according to claim 32, wherein said multiplexed stream generation step includes a node priority setting substep of setting node priorities used in the node stream generation substep, and
wherein, in said node priority setting substep, the importance of an information portion to be presented from each node to the receiving-side user is determined on the basis of a content of the node, an attribute of the node, a content of the document, an attribute of the document, the tree structure, and/or a user instruction, and a node priority is set on the basis of the determination.

35. A tree-structured document receiving method of receiving a signal formed by converting on the basis of a predetermined network protocol a node stream formed in such a manner that a node priority is set with respect to each of nodes of a tree-structured document on the basis of the importance of an information portion to be presented from the node to a receiving-side user while satisfying two conditions: a first condition that the node priority of the node is equal to or lower than that of a node which is an ancestor of that node, and a second condition that if a plurality of nodes of the same priority exist, the nodes necessarily constitute one subtree; and nodes and/or subtrees are arranged in a sequence on the basis of the node priorities, said tree-structured document receiving method having:
a receiving step of restoring the node stream from the signal received by the predetermined network protocol;
an extraction step of extracting the nodes and/or subtrees from the node stream restored in said receiving step according to the sequence of arrangement in the node stream;
a reconstruction step of adding the extracted nodes and/or subtree in the extraction order to the tree-structured document under reconstruction; and
a display step of displaying the tree-structured document in the current reconstructed state.

36. The tree-structured document receiving method according to claim 35, wherein, in the node stream restored in said receiving step, descendant substitute display information for substitute display on said display means for descendant nodes with respect to a node and/or a subtree existing as a parent of the descendant node is added immediately after the node and/or subtree existing as a parent of the descendant node;
said extraction step comprises extracting the nodes and/or subtrees and the descendant substitute display information from the node stream restored in said receiving step according to the sequence of arrangement in the node stream; and
said reconstruction step comprises adding a substitute structure portion relating to the descendant substitute display information to the tree structure under reconstruction in place of the descendant node relating to the descendant substitute display information when the descendant substitute display information is extracted in said extraction step.

37. The tree-structured document receiving method according to claim 36, wherein said reconstruction step comprises immediately replacing the substitute tree-structured portion relating to the descendant substitute display information in the tree structure under reconstruction with the descendant node when the descendant node is extracted in said extraction step while substitute display for the descendant node according to the descendant substitute display information is being performed.

38. A tree-structured document transmitting method having:
a plurality of document-by-document encoding steps each assigned processing of one tree-structured document in a plurality of tree-structured documents to be transmitted, and each including a node steam generation substep comprising generating a node stream in such a manner that a node priority is set with respect to each of nodes of a tree-structured document on the basis of the importance of an information portion to be presented from the node to a receiving-side user while satisfying two conditions: a first condition that the node priority of the node is equal to or lower than that of a node which is an ancestor of that node, and a second condition that if a plurality of nodes of the same priority exist, the nodes necessarily constitute one subtree; one assigned tree-structured document is read out from tree-structured document storage means; and
nodes and/or subtrees of the tree-structured document are arranged in a sequence on the basis of said node priorities;
a multiplexed stream generation step of generating one multiplexed stream by multiplexing the node streams in said document-by-document encoding steps, inter-document priorities being set as transmission priorities with respect to the plurality of tree-structured documents to be transmitted, sequences in which the nodes and/or subtrees of the tree-structured documents are arranged being placed in the multiplexed stream according to the inter-document priorities with respect to the tree-structured documents; and
a transmitting step of transmitting said multiplexed stream by converting said multiplexed stream on the basis of a predetermined network protocol.

39. The tree-structured document transmitting method according to claim 38, wherein said document-by-document encoding step further includes a descendant substitute display information addition substep of generating, in the node stream generation step, as said node stream, a stream in which descendant substitute display information for substitute display on display means on the receiving side for descendant nodes with respect to a node and/or a subtree existing as a parent of the descendant node is added immediately after the node and/or subtree existing as a parent of the descendant node.

40. The tree-structured document transmitting method according to claim 38, wherein said multiplexed stream generation step further includes a node priority setting substep of determining the importance of an information portion to be presented from each node to the receiving-side user on the basis of a content of the node, an attribute of the node, a content of the document, an attribute of the document, the tree structure, and/or a user instruction, and setting a node priority on the basis of the determination,
wherein the multiplexed stream generation step of said tree-structured document transmitting method includes a node priority setting substep of setting node priorities used in the node stream generation substep, and
wherein, in said node priority setting substep, the importance of an information portion to be presented from each node to the receiving-side user is determined on the basis of a content of the node, an attribute of the node, a content of the document, an attribute of the document, the tree structure, and/or a user instruction, and a node priority is set on the basis of the determination.

41. The tree-structured document transmitting method according to claim 38, further having an inter-document priority setting step of setting inter-document priorities on the basis of the contents of the documents, the attributes of the documents, the degrees of relation with a search word relating to a search request from the receiving-side user, a user instruction from a transmitting-side user, and/or a user instruction from the receiving-side user,
wherein said multiplexed stream generation step comprises restoring the multiplexed stream on the basis of the inter-document priorities set in the inter-document priority setting substep.

42. A tree-structured document receiving method of receiving a signal formed by converting on the basis of a predetermined network protocol a multiplexed stream formed in such a manner that a node priority is set with respect to each of nodes of a tree-structured document on the basis of the importance of an information portion to be presented from the node to a receiving-side user while satisfying two conditions: a first condition that the node priority of the node is equal to or lower than that of a node which is an ancestor of that node, and a second condition that if a plurality of nodes of the same priority exist, the nodes necessarily constitute one subtree; node streams are formed in each of which, with respect to one of a plurality of tree-structured documents to be presently transmitted, nodes and/or subtrees are arranged in a sequence on the basis of the node priorities related to the tree-structured document; and the multiplexed stream is formed by multiplexing the node streams relating to the tree-structured documents to be presently transmitted, sequences in which the nodes and/or subtrees of the tree-structured documents are arranged being placed in the multiplexed stream according to inter-document priorities set with respect to the tree-structured documents containing the nodes and/or subtrees, said tree-structured document receiving method having:
a receiving step of restoring the multiplexed stream from the signal received by the predetermined network protocol;
a demultiplexing step of demultiplexing the multiplexed stream into the plurality of node streams contained in the multiplexed stream;
a plurality of document-by-document decoding step each assigned processing of one node stream in the plurality of node streams demultiplexed in said demultiplexing step, and each including an extraction substep and a reconstruction substep, said extraction substep comprising extracting the nodes and/or subtrees from said processing-assigned node stream according to the sequence of arrangement in the node stream, said reconstruction substep comprising adding the nodes and/or subtree extracted in said extraction substep in the extraction order to the tree-structured document under reconstruction; and
a display step of displaying the tree-structured document under reconstruction in each document-by-document decoding step, the tree structure being displayed in the current reconstructed state at a corresponding position of the display means.

43. The tree-structured document receiving method according to claim 42, wherein, in the node stream, descendant substitute display information for substitute display on said display means for descendant nodes with respect to a node and/or a subtree existing as a parent of the descendant node is added immediately after the node and/or subtree existing as a parent of the descendant node;
said extraction substep in said document-by-document decoding step comprises extracting the nodes and/or subtrees and the descendant substitute display information from the node stream according to the sequence of arrangement in the node stream; and
said reconstruction substep in said document-by-document decoding step comprises adding a substitute structure portion relating to the descendant substitute display information to the tree structure under reconstruction in place of the descendant node relating to the descendant substitute display information when the descendant substitute display information is extracted in said extraction substep.

44. The tree-structured document receiving method according to claim 43, wherein said reconstruction substep in said document-by-document decoding step comprises immediately replacing the substitute tree-structured portion relating to the descendant substitute display information in the tree structure under reconstruction with the descendant node when the descendant node is extracted in said extraction substep while substitute display for the descendant node according to the descendant substitute display information is being performed.
